(19) United States
(12) Patent Application Publication
(10) Pub. No.: US 2026/0219051 A1
(43) Pub. Date: Jul. 30, 2026

(54) ELECTRONIC DEVICE AND CONTROL METHOD THEREFOR

(71) Applicant: SAMSUNG ELECTRONICS CO., LTD., Suwon-si (KR)

(72) Inventors: Sanghoon EUM, Suwon-si (KR); Dosung JUNG, Suwon-si (KR)

(73) Assignee: SAMSUNG ELECTRONICS CO., LTD., Suwon-si (KR)

(21) Appl. No.: 19/573,622

(22) Filed: Mar. 20, 2026

Related U.S. Application Data
(63) Continuation of application No. PCT/KR2024/014809, filed on Sep. 27, 2024.

(30) Foreign Application Priority Data
Oct. 23, 2023 (KR) 10-2023-0142453

(51) Int. Cl. G01C 21/34; G01C 21/00; H04N 9/31

(52) U.S. Cl. CPC G01C 21/3407; G01C 21/3844; G01C 21/3885; H04N 9/3173

(57) ABSTRACT

An electronic device and a control method therefor are provided. The electronic device comprises: a communication interface; a memory including at least one instruction; and at least one processor connected to the communication interface and the memory so as to control the electronic device. When an event for moving an external device to a first position occurs, the at least one processor receives, from the external device through the communication interface, information about a second position corresponding to a current position of the external device, acquires first route information for movement of the external device to the first position, the acquiring the first route information being based on information about the first and the second positions and information about a map, and transmits the first route information to the external device through the communication interface.

### CROSS-REFERENCE TO RELATED APPLICATIONS

This application is a Continuation Application of International Application PCT/KR2024/014809 filed on Sep. 27, 2024, which claims benefit of Korean Patent Application No. 10-2023-0142453, filed on Oct. 23, 2023, at the Korean Intellectual Property Office, the disclosures of which are incorporated herein in their entireties by reference.

### FIELD

The present disclosure relates to an electronic device and a control method therefor, and more particularly, to an electronic device including a projection unit for projecting an image and capable of providing a projection system in conjunction with an external device, and a control method therefor.

### BACKGROUND ART

With recent development of electronic technology and optical technology, various projectors are being utilized. A projector refers to an electronic device that projects light onto a screen (or a projection surface) to form an image on the screen.

Meanwhile, conventionally, a projector may be fixed at a specific position and project light to form an image on the screen. However, recently, the projector is not fixed at a specific position and is movable to various positions, thereby projecting light from various positions. In addition, rather than projecting an image by using a single projector, a multi-projection system is sometimes configured in conjunction with various external devices.

However, not all external devices may include sensors capable of sensing a space, which leads to a difficulty for an external device in moving by itself and configuring a multi-projection system. Therefore, there is a need to seek a method for configuring a multi-projection system by controlling an external device by using an electronic device.

### SUMMARY

According to an embodiment of the present disclosure, provided is an electronic device including: a communication interface; a memory including at least one instruction; and at least one processor connected to the communication interface and the memory and configured to control the electronic device, wherein the at least one processor is configured to: when an event for moving an external device to a first position occurs, receive, from the external device through the communication interface, information about a second position corresponding to a current position of the external device, acquire first route information for a movement of the external device to the first position, the acquiring the first route information being based on information about the first and the second positions and information about a map, and transmit the first route information to the external device through the communication interface.

The electronic device may further comprise: a sensor, wherein the at least one processor may be further configured to: when the external device is identified as being positioned within a sensing range of the sensor based on the information about the map and the information about the second position, acquire the first route information based on the information about the first and the second positions, the information about the map, and obstacle information sensed by the sensor, and transmit the acquired first route information to the external device through the communication interface.

The at least one processor may be further configured to: when the external device is identified as being positioned outside the sensing range, acquire second route information for a movement of the external device to a third position within the sensing range, the acquiring the second route information being based on the information about the second position and the information about the map, and transmit the second route information to the external device through the communication interface; and when the external device moves into the sensing range based on the second route information, acquire third route information for a movement of the external device from the third position to the first position, the acquiring the third route information being based on the information about the first and the third positions and the obstacle information, and transmit the third route information to the external device through the communication interface.

The at least one processor may be further configured to: when the external device is identified as being positioned outside the sensing range, transmit the first route information to the external device through the communication interface; and by using the sensor, when the external device is identified as being positioned within the sensing range while the external device moves to the first position based on the first route information, acquire the first route information based on the obstacle information, and transmit the acquired first route information to the external device through the communication interface.

When the external device is identified as being positioned outside the sensing range, the external device may be moved into the sensing range by using a control device capable of controlling movement of the external device.

The external device may be a device including at least one of a projector, a speaker, or a battery.

The at least one processor may be further configured to: when at least one of the projector, the speaker, or the battery is included in the external device, receive, from the external device through the communication interface, information about the device included in the external device.

The event for moving the external device to the first position may be an event in which a user command is input for operating a multi-projection function by using the external device including the projector and the electronic device, and the at least one processor may be further configured to: when the event in which the user command is input occurs, acquire information about the first position of the external device to project an image for operating the multi-projection function, the acquiring the information about the first position being based on the information about the map, information about a position of the electronic device, and information about a position of a projection surface.

The event for moving the external device to the first position may be an event in which a user command is input for operating a multi-speaker function by using the external device including the speaker, and the at least one processor may be configured to: when the event in which the user command is input occurs, acquire information about the first position for operating the multi-speaker function, the acquiring the information about the first position being based on the information about the map, information about a position of the electronic device, and information about a user position.

The event for moving the external device to the first position may be an event in which the external device includes a battery and a remaining battery level of the electronic device is equal to or less than a threshold value, and the at least one processor may be further configured to: when the remaining battery level is detected to be equal to or less than the threshold value, acquire information about the first position corresponding to a position of the electronic device.

According to an embodiment of the present disclosure, provided is a control method performed by an electronic device, the method comprising: when an event for moving an external device to a first position occurs, receiving, from the external device, information about a second position corresponding to a current position of the external device; acquiring first route information for a movement of the external device to the first position, the acquiring the first route information being based on the information about the first and the second positions and information about a map; and transmitting the first route information to the external device.

The acquiring of the first route information may comprise: when the external device is identified as being positioned within a sensing range of a sensor included in the electronic device based on the information about the map and the information about the second position, acquiring the first route information based on the information about the first and the second positions, the information about the map, and obstacle information sensed by the sensor.

The acquiring of the first route information may further comprise: when the external device is identified as being positioned outside the sensing range, acquiring second route information for a movement of the external device to a third position within the sensing range, the acquiring the second route information being based on the information about the second position and the information about the map, and transmitting the second route information to the external device; and when the external device moves into the sensing range based on the second route information, acquiring third route information for a movement of the external device from the third position to the first position, the acquiring the third route information being based on information about the first and the third positions and the obstacle information.

The acquiring of the first route information may further comprise: when the external device is identified as being positioned outside the sensing range, transmitting the first route information to the external device; and by using the sensor, when the external device is identified as being positioned within the sensing range while the external device moves to the first position based on the first route information, acquiring the first route information based on the obstacle information.

When the external device is identified as being positioned outside the sensing range, the external device may be moved into the sensing range by using a control device capable of controlling movement of the external device.

The external device may be a device including at least one of a projector, a speaker, or a battery.

The method may include: when at least one of the projector, the speaker, or the battery is included in the external device, receiving, from the external device, information about the device included in the external device.

The event for moving the external device to the first position may be an event in which a user command is input for operating a multi-projection function by using the external device including the projector and the electronic device, and the method may include: when the event in which the user command is input occurs, acquiring information about the first position of the external device to project an image for operating the multi-projection function on the basis of the information about the map, information about a position of the electronic device, and information about a position of a projection surface.

The event for moving the external device to the first position may be an event in which a user command is input for operating a multi-speaker function by using the external device including the speaker, and the method may include: when the event in which the user command is input occurs, acquiring information about the first position for operating the multi-speaker function on the basis of the information about the map, information about a position of the electronic device, and information about a user position.

The event for moving the external device to the first position may be an event in which the external device includes a battery and a remaining battery level of the electronic device is equal to or less than a threshold value, and the method may include: when the remaining battery level is detected to be equal to or less than the threshold value, acquiring information about the first position corresponding to a position of the electronic device.

### BRIEF DESCRIPTION OF DRAWINGS

FIG. 1 is a diagram illustrating a projection system including an electronic device and an external device according to an embodiment of the present disclosure;

FIG. 2 is a block diagram illustrating a configuration of the electronic device according to an embodiment of the present disclosure;

FIG. 3 is a perspective view illustrating an exterior of the electronic device according to an embodiment of the present disclosure;

FIG. 4 is a block diagram illustrating a configuration of the external device according to an embodiment of the present disclosure;

FIGS. 5A and 5B are diagrams illustrating a method of acquiring route information when the external device is positioned within a sensing range according to an embodiment of the present disclosure;

FIGS. 6A and 6B are diagrams illustrating a method of acquiring route information when the external device is positioned outside a sensing range according to an embodiment of the present disclosure;

FIG. 7 is a flowchart illustrating a method of acquiring route information when the external device is positioned outside a sensing range according to another embodiment of the present disclosure;

FIGS. 8A to 8C are diagrams illustrating an embodiment in which the external device is controlled using a control device according to an embodiment of the present disclosure;

FIGS. 9A to 9C are diagrams illustrating an external device including various devices according to an embodiment of the present disclosure;

FIG. 10 is a diagram illustrating an embodiment related to a plurality of external devices each including a projector according to an embodiment of the present disclosure;

FIG. 11 is a diagram illustrating an embodiment related to a plurality of external devices each including a speaker according to an embodiment of the present disclosure;

FIGS. 12A and 12B are diagrams illustrating an embodiment related to an external device including a battery according to an embodiment of the present disclosure;

FIGS. 13A and 13B are diagrams illustrating a single projection function and a multi-projection function according to an embodiment of the present disclosure;

FIG. 14 is a sequence diagram illustrating a method of operating a multi-projection function in conjunction with a plurality of external devices according to an embodiment of the present disclosure; and

FIG. 15 is a flowchart illustrating a control method for an electronic device according to an embodiment of the present disclosure.

### DETAILED DESCRIPTION

The present disclosure may be variously modified and have several embodiments, and specific embodiments of the present disclosure are thus illustrated in the accompanying drawings and described in detail in the specification. However, it should be understood that the scope of the present disclosure are not limited to specific embodiments, and include all modifications, equivalents, and alternatives according to an embodiment of the present disclosure. Throughout the accompanying drawings, similar components are denoted by similar reference numerals.

In describing the present disclosure, omitted is a detailed description of a case where it is decided that a detailed description of the known functions or configurations related to the present disclosure may unnecessarily obscure the gist of the present disclosure.

In addition, the following embodiment may be modified in several different forms, and the scope and spirit of the present disclosure are not limited to the following embodiments. Rather, these embodiments make the present disclosure thorough and complete, and are provided to completely convey the spirit of the present disclosure to those skilled in the art.

Terms used in the present disclosure are used only to describe the specific embodiments rather than limit the scope of the present disclosure. A term of a singular number may include its plural number unless explicitly indicated otherwise in the context.

In the present disclosure, the expression such as “have,” “may have,” “include,” or “may include,” indicates the presence of a corresponding feature (e.g., a numerical value, a function, an operation, or a component such as a part), and does not exclude the presence of an additional feature.

In the present disclosure, the expression such as “A or B,” “least one of A and/or B,” or “one or more of A and/or B” may include all possible combinations of items enumerated together. For example, “A or B,” “at least one of A and B,” or “at least one of A or B” may indicate all of 1) a case in which at least one A is included, 2) a case in which at least one B is included, or 3) a case in which both of at least one A and at least one B are included.

The expressions such as “first” and “second,” used in the present disclosure, may indicate various components regardless of the sequence and/or importance of the components. These expressions are only used to distinguish one component and another component from each other, and do not limit the corresponding components.

When any component (e.g., a first component) is mentioned to be “(operatively or communicatively) coupled with/to” or “connected to” another component (e.g., a second component), it should be understood that the any component is directly coupled to another component or may be coupled to another component through yet another component (e.g., a third component).

On the other hand, when any component (e.g., the first component) is mentioned to be “directly coupled with/to” or “directly connected to” another component (e.g., the second component), it should be understood that yet another component (e.g., the third component) is not present between any component and another component.

An expression such as “configured (or set) to,” used in the present disclosure, may be replaced by an expression such as “suitable for,” “having the capacity to,” “designed to,” “adapted to,” “made to,” or “capable of,” depending on a context. The expression “configured (or set) to” does not necessarily indicate “specifically designed to” in terms of hardware.

Instead, the expression “a device configured to,” in any context, may indicate that the device may “perform~” together with another device or component. For example, a “processor configured (or set) to perform A, B, and C” may indicate a dedicated processor (e.g., an embedded processor) that may perform the corresponding operations or a generic-purpose processor (e.g., a central processing unit (CPU) or an application processor) that may perform the corresponding operations by executing one or more software programs stored in a memory device.

In the embodiments, a “module” or a “part” may perform at least one function or operation, and be implemented by hardware or software or be implemented by a combination of hardware and software. In addition, a plurality of “modules” or a plurality of “parts” may be integrated in at least one module and be implemented by at least one processor except for a “module” or a “part” that needs to be implemented by specific hardware.

Meanwhile, various elements and regions in the drawings are schematically illustrated. Therefore, the spirit of the present disclosure is not limited by relative sizes or intervals illustrated in the accompanying drawings.

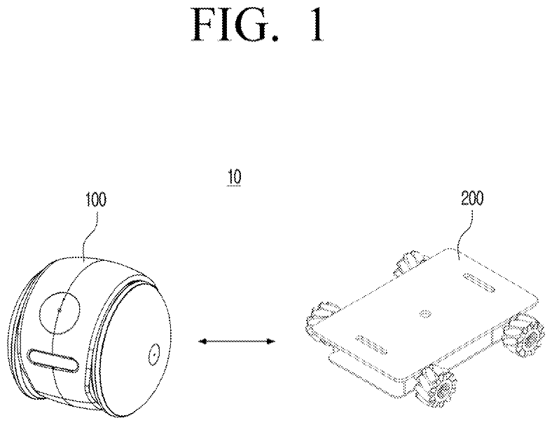

FIG. 1 is a diagram illustrating a projection system 10 including an electronic device 100 and an external device 200 according to an embodiment of the present disclosure. As illustrated in FIG. 1, a projection system 10 may include an electronic device 100 and an external device 200. Here, the electronic device 100 may be a movable projector including a projection unit for projecting an image, is not limited thereto, and may be implemented as any of various electronic devices such as a television (TV), a set-top box, a smartphone, a tablet personal computer (PC), or a robot. The external device 200 may be an electronic device including a driving unit as illustrated in FIG. 1, but is not limited thereto, and may be implemented as any of various devices such as a movable projector or a robot.

The electronic device 100 may include the projection unit for projecting an image, and may move an indoor space by using the driving unit. The external device 200 may include various devices (or auxiliary devices or accessory devices such as a projector, a speaker, or a battery), and may move in the indoor space. Here, the external device 200 may not include a sensor capable of sensing a space that is included in the electronic device 100, or may include a sensor having performance inferior to that of the sensor included in the electronic device 100.

The electronic device 100 may configure the projection system in conjunction with at least one external device 200. In particular, the electronic device 100 may control at least one external device 200 to move to a first position (or a target position). Specifically, the electronic device 100 may acquire information about a second position corresponding to a current position of the external device 200 from the external device 200. In addition, the electronic device 100 may acquire route information for movement of the external device 200 from the second position to the first position on the basis of information about a stored map. The electronic device 100 may transmit the acquired route information to the external device 200. The external device 200 may move to the first position on the basis of the received route information.

Here, the electronic device 100 may transmit route information reflecting obstacle information to the external device 200 depending on whether the external device 200 is positioned within a sensing range. Here, the sensing range may refer to a range within which the sensor included in the electronic device 100 is capable of sensing the external device 200 or movement of the external device 200. When the external device 200 is positioned within the sensing range, the electronic device 100 may acquire (or modify) the route information in real time on the basis of the obstacle information sensed by the sensor and transmit the route information to the external device 200. Accordingly, the external device 200 may move to the first position along an optimal route.

In addition, the electronic device 100 may acquire information for configuring a multi-projection system on the basis of information about a device included (or mounted) in the external device 200. Here, the information for configuring the multi-projection system may include information about the first position to which the external device 200 moves, information about a function of the external device 200, control information for controlling the external device 200, and the like. In addition, the electronic device 100 may transmit information about the configured multi-projection system to the external device 200, and the external device 200 may move to the first position and control the device included in the external device 200 on the basis of the information about the multi-projection system, thereby operating as the multi-projection system together with the electronic device 100.

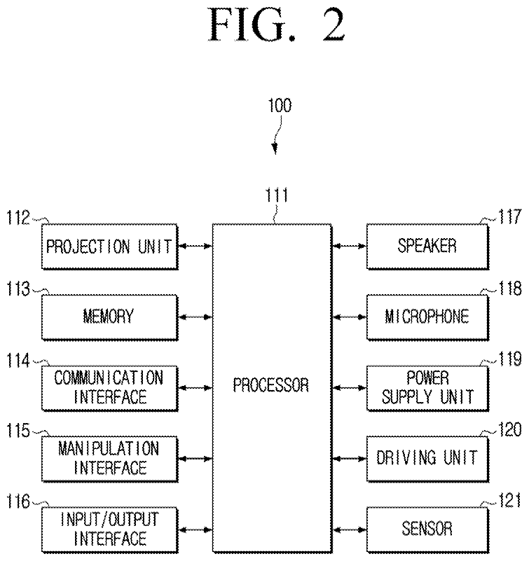

FIG. 2 is a block diagram illustrating a configuration of the electronic device 100 according to an embodiment of the present disclosure. Referring to FIG. 2, the electronic device 100 may include at least one of a processor 111, a projection unit 112, a memory 113, a communication interface 114, a manipulation interface 115, an input/output interface 116, a speaker 117, a microphone 118, a power supply unit 119, a driving unit 120, or a sensor 121. In an embodiment, the processor 111 may include one or more processors. Meanwhile, the components illustrated in FIG. 2 are merely examples, and some components may be omitted, and additional components may be added.

The projection unit 112 is a component for projecting an image to the outside. According to various embodiments of the present disclosure, the projection unit 112 may be implemented as any of various projection types (e.g., a cathode-ray tube (CRT) type, a liquid crystal display (LCD) type, a digital light processing (DLP) type, or a laser type). For example, the CRT type may basically use the same principle as a CRT monitor. The CRT type may display an image on a screen by magnifying the image by using a lens disposed in front of the cathode-ray tube (CRT). The CRT type may be classified into a single-tube type and a three-tube type based on the number of cathode-ray tubes, and in case of the three-tube type, red, green, and blue cathode-ray tubes may be implemented separately.

In another example, the LCD type may display an image by passing light output from a light source through a liquid crystal. The LCD type may be classified into a single-panel type and a three-panel type. In case of the three-panel type, light output from the light source may be separated into red, green, and blue by a dichroic mirror (i.e., a mirror that reflects light of a specific color and transmits the others), may then pass through the liquid crystal, and may then be focused again onto a single point.

In another example, the DLP type may display an image by using a digital micromirror device (DMD) chip. The DLP-type projection unit may include a light source, a color wheel, the DMD chip, a projection lens, or the like. Light output from the light source may be colored as light passes through a rotating color wheel. Light passed through the color wheel may be input to the DMD chip. The DMD chip may include numerous micromirrors and reflect light input into the DMD chip. The projection lens may serve to magnify light reflected from the DMD chip into an image size.

In another example, the laser type may include a diode-pumped solid-state (DPSS) laser and a galvanometer. The laser type that outputs various colors may use a laser in which three DPSS lasers are respectively installed for red, green, and blue (RGB) colors, and their optical axes then overlap with one another by using a special mirror. The galvanometer may include a mirror and a high-power motor to move the mirror at a high speed. For example, the galvanometer may rotate the mirror at up to 40 KHz/sec. The galvanometer may be mounted in a scanning direction. In general, the projector may perform a flatbed scanning, and the galvanometer may thus also be divided into x and y axes.

Meanwhile, the projection unit 112 may include various types of light sources. For example, the projection unit 112 may include at least one light source among a lamp, a light-emitting diode (LED), and a laser.

The projection unit 112 may output an image in an aspect ratio of 4:3, an aspect ratio of 5:4, or a wide aspect ratio of 16:9, based on a purpose of the electronic device 100, a user setting, or the like, and may output the image having any of various resolutions such as wide video graphics array (WVGA, 854×480 pixels), super video graphics array (SVGA, 800×600 pixels), extended graphics array (XGA, 1024×768 pixels), wide extended graphics array (WXGA, 1280×720 pixels), WXGA (1280×800 pixels), super extended graphics array (SXGA, 1280×1024 pixels), ultra extended graphics array (UXGA, 1600×1200 pixels) and full high-definition (full HD, 1920×1080 pixels), based on the aspect ratio.

Meanwhile, the projection unit 112 may perform various functions to adjust the output image under control of the processor 111. For example, the projection unit 112 may perform a zoom function, a keystone function, a quick corner (four-corner) keystone function, a lens shift function, or the like.

Specifically, the projection unit 112 may enlarge or reduce an image based on its distance (i.e., a projection distance) from a screen. That is, the projection unit 112 may perform the zoom function based on the distance from the screen. Here, the zoom function may include a hardware method for adjusting a screen size by moving a lens, and a software method for adjusting the screen size by cropping the image, or the like. If the zoom function is performed, a focus of the image is required to be adjusted. For example, a method for adjusting the focus may include a manual focusing method and an electric focusing method. The manual focusing method refers to a method of manually adjusting the focus, and the electric focusing method refers to a method in which the projector automatically adjusts the focus by using a motor built therein upon performing the zoom function. Meanwhile, when the zoom function is performed, the projection unit 112 may provide a digital zoom function by using software, and may provide an optical zoom function that performs the zoom function in which the zoom function is performed by moving the lens by using the driving unit 120.

In addition, the projection unit 112 may perform the keystone correction function. If a projection height does not match the front projection, the screen may be distorted upward or downward. The keystone correction function refers to a function for correcting such screen distortion. For example, if the screen is distorted leftward or rightward, the distortion may be corrected by using a horizontal keystone, and if the screen is distorted upward or downward, the distortion may be corrected by using a vertical keystone. The quick corner (four-corner) keystone correction function refers to a function for correcting the screen when a center region of the screen is normal and a corner region thereof is unbalanced. The lens shift function refers to a function for moving the screen position without distorting the screen when the screen is out of the projection range.

Meanwhile, the projection unit 112 may provide the zoom, keystone, and focusing functions by automatically analyzing a surrounding environment and a projection environment without a user input. Specifically, the projection unit 112 may automatically provide the zoom, keystone, and focusing functions based on a distance between the electronic device 100 and a screen, information about a space where the electronic device 100 is currently positioned, information about an amount of ambient light, or the like, sensed by the sensor (e.g., a depth camera, a distance sensor, an infrared sensor, or an illuminance sensor).

In addition, the projection unit 112 may provide an illumination function by using a light source. In particular, the projection unit 112 may provide the illumination function by outputting light from the light source such as an LED. According to the various embodiments, the projection unit 112 may include one LED, and according to another embodiment, the electronic device 100 may include a plurality of LEDs. In an implementation example, the projection unit 112 may output light from the light source by using a surface-emitting LED. The surface-emitting LED may refer to an LED in which an optical sheet is disposed on an upper side of the LED for evenly distributing light from the light source and outputting the same. Specifically, when light from the light source is output through the LED, light from the light source may be evenly distributed through the optical sheet, and light from the light source that is distributed through the optical sheet may be incident on a display panel.

Meanwhile, the projection unit 112 may provide a user with a dimming function for adjusting an intensity of light from the light source. Specifically, if the user input for adjusting the intensity of light from the light source is received from the user through the manipulation interface 115 (e.g., a touch display button or a dial button), the projection unit 112 may control the LED to output light at an intensity of light from the light source corresponding to the received user input.

In addition, the projection unit 112 may provide the dimming function based on content analyzed by the processor 111 without the user input. Specifically, the projection unit 112 may control the LED to output light at the intensity of light from the light source based on information (e.g., content type or content brightness) about the currently-provided content.

Meanwhile, the projection unit 112 may control a color temperature under the control of the processor 111. Here, the processor 111 may control the color temperature based on content. Specifically, when the content to be output is identified, the processor 111 may acquire frame-by-frame color information of the content whose output is determined. In addition, the processor 111 may control the color temperature based on the acquired frame-by-frame color information. Here, the processor 111 may acquire at least one major color of a frame based on the frame-by-frame color information. In addition, the processor 111 may adjust the color temperature based on at least one acquired major color. For example, the color temperature adjustable by the processor 111 may be classified into a warm type or a cold type. Here, it is assumed that a frame to be output (hereinafter, an output frame) includes a scene where a fire occurs. The processor 111 may identify (or acquire) that the major color is red based on the color information included in a current output frame. In addition, the processor 111 may identify the color temperature corresponding to the identified major color (red). Here, the color temperature corresponding to red may be the warm type. Meanwhile, the processor 111 may use the artificial intelligence model to acquire the color information or major color of the frame. According to the various embodiments, the artificial intelligence model may be stored in the electronic device 100 (e.g., the memory 113). According to another embodiment, the artificial intelligence model may be stored in an external server capable of communicating with the electronic device 100.

The memory 113 may be implemented as an internal memory such as a read-only memory (ROM) (e.g., an electrically erasable programmable read-only memory (EEPROM) or a random access memory (RAM) included in the processor 111, or may be implemented as a memory separate from the processor 111. The memory 113 may be implemented as the memory embedded in the electronic device 100 or the memory detachable from the electronic device 100 based on a data storage purpose. For example, data for driving the electronic device 100 may be stored in the memory embedded in the electronic device 100, and data for extended functions of the electronic device 100 may be stored in the memory detachable from the electronic device 100.

Meanwhile, the memory embedded in the electronic device 100 may be implemented as at least one of a volatile memory (e.g., a dynamic random access memory (DRAM), a static random access memory (SRAM), or a synchronous dynamic random access memory (SDRAM)) or a non-volatile memory (e.g., a one time programmable read-only memory (OTPROM), a programmable read-only memory (PROM), an erasable and programmable read-only memory (EPROM), an electrically erasable and programmable read-only memory (EEPROM), a mask ROM, a flash ROM, a flash memory (e.g., a NAND flash or a NOR flash), a hard drive, or a solid state drive (SSD)); and the memory detachable from the electronic device 100 may be implemented as a memory card (e.g., a compact flash (CF), a secure digital (SD), a micro secure digital (Micro-SD), a mini secure digital (Mini-SD), an extreme digital (xD), or a multi-media card (MMC)) or an external memory connectable to a universal serial bus (USB) port (e.g., a USB memory).

The memory 113 may store at least one instruction related to the electronic device 100. In addition, the memory 113 may store an operating system (O/S) for driving the electronic device 100. In addition, the memory 113 may store various software programs or applications for operating the electronic device 100 according to the various embodiments of the present disclosure. In addition, the memory 113 may include a semiconductor memory such as a flash memory or a magnetic storage medium such as a hard disk.

Specifically, the memory 113 may store various software modules for operating the electronic device 100 according to the various embodiments of the present disclosure, and the processor 111 may control an operation of the electronic device 100 by executing the various software modules stored in the memory 113. That is, the memory 113 may be accessed by the processor 111, and the processor may perform reading, writing, modification, deletion, update, or the like of data.

In particular, the memory 113 may store the information about the map representing an indoor space in which the electronic device 100 is positioned. Here, the map may include a drawing in which a planar structure in an indoor space is reduced at a predetermined ratio and is indicated by predetermined symbols. For example, the map may include a drawing indicating the planar structure in an indoor space by lines. However, the map is not limited thereto, and may include positions of main objects inside the house.

Meanwhile, the map according to an embodiment of the present disclosure may correspond to a two-dimensional map, which is merely an embodiment, and may correspond to a three-dimensional map.

Meanwhile, the term “memory 113” in the present disclosure is used to include a storage unit, a ROM (not shown) or a RAM (not shown) installed in the processor 111, or a memory card (not shown) mounted on the electronic device 100 (e.g., a micro SD card or a memory stick).

The communication interface 114 is a component for performing communication with various types of external devices by using various types of communication methods. The communication interface 114 may include a wireless communication module or a wired communication module. Here, each communication module may be implemented as at least one hardware chip.

The wireless communication module refers to a module for performing communication with the external device in a wireless manner. For example, the wireless communication module may include at least one module selected from a wireless fidelity (Wi-Fi) module, a Bluetooth module, an infrared communication module, or other communication modules.

The Wi-Fi module and Bluetooth module may perform communication in a Wi-Fi manner and a Bluetooth manner, respectively. In case of using the Wi-Fi module or the Bluetooth module, the communication interface 114 may first transmit and receive various connection information such as a service set identifier (SSID) or a session key, and connect the communication based on this connection information, and then transmit and receive various information.

The infrared communication module may perform communication based on infrared data association (IrDA) technology that wirelessly transmits data in a short distance using an infrared ray between visible light and millimeter waves.

Other communication modules may include at least one communication chip performing the communication based on various wireless communication standards such as Zigbee, third generation (3G), third generation partnership project (3GPP), long term evolution (LTE), LTE advanced (LTE-A), fourth generation (4G), and fifth generation (5G), in addition to the above-described communication methods.

The wired communication module refers to a module for performing the communication with the external device in a wired manner. For example, the wired communication module may include at least one of a local area network (LAN) module, an Ethernet module, a pair cable, a coaxial cable, an optical fiber cable, or an ultrawideband (UWB) module.

In particular, the communication interface 114 may perform communication with the external device 200. The communication interface 114 may receive, from the external device 200, information about the external device 200 (e.g., the information about the current position of the external device 200 or the information about the device included in the external device 200). The communication interface 114 may transmit the route information to the external device 200, and may transmit information about the multi-projection system.

The manipulation interface 115 may include various types of input devices. For example, the manipulation interface 115 may include a physical button. Here, the physical button may include a function key, a directional key (e.g., a four-way key), or a dial button. According to the various embodiments, the physical button may be implemented as a plurality of keys. According to another embodiment, the physical button may be implemented as one key. If the physical button is implemented as one key, the electronic device 100 may receive a user input in which one key is pressed for a threshold time or more. Upon receiving the user input in which one key is pressed for the threshold time or more, the processor 111 may perform a function corresponding to the user input. For example, the processor 111 may provide an illumination function based on the user input.

In addition, the manipulation interface 115 may receive the user input using a non-contact method. If the user input is received using a contact method, a physical force is required to be transmitted to the electronic device 100. Therefore, there is a need for a method for controlling the electronic device 100 regardless of the physical force. Specifically, the manipulation interface 115 may receive a user gesture and perform an operation corresponding to the received user gesture. Here, the manipulation interface 115 may receive the user gesture from the sensor (e.g., the image sensor or the infrared sensor).

In addition, manipulation interface 115 may receive the user input by using a touch method. For example, the manipulation interface 115 may receive the user input from a touch sensor. According to the various embodiments, the touch method may be implemented in a non-contact manner. For example, the touch sensor may determine whether a user body approaches within a threshold distance. The touch sensor may identify the user input even if the user does not come into contact with the touch sensor. In another implementation example, the touch sensor may identify the user input if the user comes into contact with the touch sensor.

Meanwhile, the electronic device 100 may receive the user input in various ways other than the manipulation interface 115 described above. In the various embodiments, the electronic device 100 may receive the user input from an external remote control device. Here, the external remote control device may refer to a remote control device corresponding to the electronic device 100 (e.g., a dedicated control device of the electronic device 100) or a portable communication device of the user (e.g., a smartphone or a wearable device). Here, the portable communication device of the user may store an application for controlling the electronic device 100. The portable communication device may acquire the user input from the application stored therein and transmit the acquired user input to the electronic device 100. The electronic device 100 may receive the user input from the portable communication device and perform an operation corresponding to a user control command.

Meanwhile, the electronic device 100 may receive the user input by using voice recognition. According to the various embodiments, the electronic device 100 may receive the user voice from the microphone included in the electronic device 100. According to another embodiment, the electronic device 100 may receive the user voice from the microphone or the external device. Specifically, the external device may acquire the user voice from the microphone of the external device and transmit the acquired user voice to the electronic device 100. The user voice transmitted from the external device may be audio data or digital data converted from the audio data (e.g., audio data converted into a frequency domain). The electronic device 100 may perform an operation corresponding to the received user voice. Specifically, the electronic device 100 may receive the audio data corresponding to the user voice from the microphone. In addition, the electronic device 100 may convert the received audio data into the digital data. In addition, the electronic device 100 may convert the converted digital data into text data by using a speech-to-text (STT) function. According to the various embodiments, the electronic device 100 may directly perform the speech-to-text (STT) function. According to another embodiment, the external server may perform the speech-to-text (STT) function. The electronic device 100 may transmit the digital data to the external server. The external server may convert the digital data into the text data and acquire control command data based on the converted text data. The external server may transmit the control command data to the electronic device 100 (Here, the control command data may also include the text data). The electronic device 100 may perform an operation corresponding to the user voice based on the acquired control command data.

Meanwhile, the electronic device 100 may provide a voice recognition function by using a single assistant (or an AI assistant, e.g., Bixby™), which is only one of the various embodiments, and may provide the voice recognition function by using a plurality of assistants. Here, the electronic device 100 may provide the voice recognition function by selecting one of the plurality of assistants based on a trigger word corresponding to the assistant or a specific key included in a remote control.

Meanwhile, electronic device 100 may receive the user input by using screen interaction. The screen interaction may refer to a function for identifying whether a predetermined event occurs based on an image projected by the electronic device 100 on a screen (or a projection surface) and acquiring the user input based on the predetermined event. Here, the predetermined event may refer to an event in which a predetermined object is identified at a specific position (e.g., a position at which a user interface (UI) for receiving the user input is projected). Here, the predetermined object may include at least one of a body part of the user (e.g., a finger), a pointer, or a laser point. If the predetermined object is identified at the position corresponding to the projected UI, the electronic device 100 may identify that the user input for selecting the projected UI is received. For example, the electronic device 100 may project a guide image for guiding the UI to be displayed on the screen. In addition, the electronic device 100 may identify whether the user selects the projected UI. Specifically, the electronic device 100 may identify that the user selects the projected UI if the predetermined event is identified at the position of the projected UI. Here, the projected UI may include at least one item. Here, the electronic device 100 may perform a space analysis to identify whether the predetermined event occurs at the position of the projected UI. Here, the electronic device 100 may perform the space analysis by using the sensor (e.g., the image sensor, the infrared sensor, the depth camera, or the distance sensor). By performing the space analysis, the electronic device 100 may identify whether the predetermined event occurs at the specific position (the position at which the UI is projected). In addition, if the predetermined event is identified as occurring at the specific position (the position at which the UI is projected), the electronic device 100 may identify that the user input for selecting the UI corresponding to the specific position is received.

In particular, the manipulation interface 115 may receive a user command for operating a multi-projection function. In an embodiment, a touch or jog icon for receiving a user command may be provided through a display. In addition, when the touch or jog icon is selected through the touch display or the like of the manipulation interface 115, the electronic device 100 may receive a user command (e.g., a user command for operating the multi-projection function).

The input/output interface 116 is a component for inputting and outputting at least one of the audio signal or an image signal. The input/output interface 116 may receive at least one of the audio signal or the image signal from the external device 200, and output the control command to the external device 200.

In an implementation example, the input/output interface 116 may be implemented as including an interface for inputting and outputting only the audio signal and an interface for inputting and outputting only the image signal, or as a single interface for inputting and outputting both the audio signal and the image signal.

Meanwhile, according to the various embodiments of the present disclosure, the input/output interface 116 may be implemented as at least one of wired input/output interfaces such as a high definition multimedia interface (HDMI), a mobile high-definition link (MHL), a universal serial bus (USB), a USB C-type, a DisplayPort (DP), Thunderbolt, a video graphics array (VGA) port, a red-green-blue (RGB) port, a D-subminiature (D-SUB), or a digital visual interface (DVI). According to the various embodiments, the wired input/output interface may be implemented as including an interface for inputting and outputting only the audio signal and an interface for inputting and outputting only the image signal, or as one interface for inputting and outputting both the audio signal and the image signal.

In addition, the electronic device 100 may receive data through the wired input/output interface, which is only one of the various embodiments, and may receive power through the wired input/output interface. For example, the electronic device 100 may receive power from an external battery through the USB C-type or from a power outlet through a power adapter. In another example, the electronic device 100 may receive power from the external device 200 (e.g., a laptop or a monitor) through the DP.

Meanwhile, the audio signal may be implemented to be input through the wired input/output interface, and the image signal may be implemented to be input through a wireless input/output interface (or the communication interface 114). Alternatively, the audio signal may be implemented to be input through the wireless input/output interface (or the communication interface 114), and the image signal may be implemented to be input through the wired input/output interface.

The speaker 117 is a component for outputting an audio signal. In particular, the speaker 117 may include an audio output mixer, an audio signal processor, and an audio output module. The audio output mixer may synthesize a plurality of audio signals to be output into at least one audio signal. For example, the audio output mixer may synthesize an analog audio signal with another analog audio signal (e.g., an analog audio signal received from an external source) into at least one analog audio signal. The audio output module may include the speaker or an output terminal. According to the various embodiments, the audio output module may include a plurality of speakers. Here, the audio output module may be disposed inside a body, and audio emitted by covering at least a portion of a diaphragm included in the audio output module may pass through a waveguide and be transmitted to the outside of the body. The audio output module may include a plurality of audio output units, and the plurality of audio output units may be arranged symmetrically on an exterior of the body, thereby emitting the audio in all directions, i.e., 360 degrees.

The microphone 118 is a component for receiving user voice or other sound and converting the same into audio data. The microphone 118 may receive the user voice when activated. For example, the microphone 118 may be an integral type integrally formed on an upper side, a front side, a side portion, or the like of the electronic device 100. The microphone 118 may include various configurations such as a microphone for collecting the user voice in an analog form, an amplifier circuit for amplifying the collected user voice, an analog to digital (A/D) conversion circuit for sampling the amplified user voice and converting the same into a digital signal, and a filter circuit for removing a noise component from the converted digital signal, and the like.

The power supply unit 119 may receive power from an external source and supply power to the various components of the electronic device 100. According to the various embodiments of the present disclosure, the power supply unit 119 may receive power by using various methods. In the various embodiments, the power supply unit 119 may receive power by using a connector. In addition, the power supply unit 119 may receive power by using a direct current (DC) power cord of 220 V. However, the present disclosure is not limited thereto, and the electronic device 100 may receive power by using a USB power cord or may receive power by using a wireless charging method.

In addition, the power supply unit 119 may receive power from an internal battery or an external battery. According to the various embodiments of the present disclosure, the power supply unit 119 may receive power from the internal battery. For example, the power supply unit 119 may charge power of the internal battery by using at least one of the DC power cord of 220 V, the USB power cord, or a USB C-Type power cord, and may receive power from the charged internal battery. In addition, according to the various embodiments of the present disclosure, the power supply unit 119 may receive power from the external battery. For example, the power supply unit 119 may receive power from the external battery when the electronic device 100 and the external battery are connected to each other by using various wired communication methods such as the USB power cord, the USB C-Type power cord, and a socket groove. That is, the power supply unit 119 may receive power directly from the external battery, or charge the internal battery by using the external battery and then receive power from the charged internal battery.

The power supply unit 119 according to the present disclosure may receive power by using at least one of the plurality of power supply methods described above.

Meanwhile, regarding power consumption, the electronic device 100 may have power consumption equal to or lower than a predetermined value (e.g., 43 W) due to a socket type, another standard, or the like. Here, the electronic device 100 may change the power consumption to reduce power consumption when a battery is used. That is, the electronic device 100 may change the power consumption based on the power supply method, power usage, or the like.

The driving unit 120 may drive at least one hardware component included in the electronic device 100. The driving unit 120 may generate the physical force and transmit the physical force to at least one hardware component included in the electronic device 100.

Here, the driving unit 120 may generate driving power for movement of the hardware component included in the electronic device 100 (e.g., movement of the electronic device 100) or a rotation operation of a configuration (e.g., rotation of a projection lens).

The driving unit 120 may adjust a projection direction (or projection angle) of a projection unit 122. In addition, the driving unit 120 may move the position of the electronic device 100. Here, the driving unit 120 may control a movement member 109 to move the electronic device 100. For example, the driving unit 120 may control the movement member 109 by using a motor and wheels.

The sensor 121 may include at least one sensor. Specifically, the sensor 121 may include at least one of a tilt sensor for sensing tilt of the electronic device 100 or an image sensor for capturing an image. Here, the tilt sensor may be implemented as an accelerometer or a gyro sensor, and an image sensor may be implemented as the camera or the depth camera. Meanwhile, the tilt sensor may be referred to as a movement sensor. In addition, the sensor 121 may include various sensors other than the tilt sensor or the image sensor. For example, the sensor 121 may include an illuminance sensor or a distance sensor. The distance sensor may be implemented as a time of flight (ToF) sensor. In addition, the sensor 121 may include a light detection and ranging (LiDAR) sensor.

In particular, the sensor 121 may acquire a sensing value for acquiring information on whether the external device 200 is positioned within the sensing range by using at least one sensor. In addition, the sensor 121 may acquire the obstacle information within the sensing range by using at least one sensor.

Meanwhile, the electronic device 100 may control an illumination function in conjunction with an external device. Specifically, the electronic device 100 may receive illumination information from the external device. Here, the illumination information may include at least one of brightness information or color temperature information set by the external device. Here, the external device may be a device connected to the same network as the electronic device 100 (e.g., an internet of things (IoT) device included in the same home/company network) or a device communicable with the electronic device 100 even though the device is not included in the same network as the electronic device 100 (e.g., a remote control server). For example, it is assumed that an external illumination device (e.g., the IoT device) included in the same network as the electronic device 100 outputs red illumination at brightness of 50. The external illumination device (e.g., the IoT device) may directly or indirectly transmit illumination information (e.g., information indicating that red illumination is output at brightness of 50) to the electronic device 100. Here, the electronic device 100 may control output of a light source on the basis of the illumination information received from the external illumination device. For example, when the illumination information received from the external illumination device includes the information indicating that red illumination is output at brightness of 50, the electronic device 100 may output red illumination at brightness of 50.

Meanwhile, the electronic device 100 may control the illumination function on the basis of biometric information. Specifically, the processor 111 may acquire the user's biometric information. Here, the biometric information may include at least one of the user's body temperature, heart rate, blood pressure, respiration, or electrocardiogram. Here, the biometric information may include various types of information in addition to the information described above. For example, the electronic device 100 may include a sensor for measuring the biometric information. The processor 111 may acquire the user's biometric information through the sensor and may control output of a light source on the basis of the acquired biometric information. In another example, the processor 111 may receive the biometric information from an external device through the input/output interface 116. Here, the external device may be the user's portable communication device (e.g., a smartphone or a wearable device). The processor 111 may acquire the user's biometric information from the external device and may control output of the light source on the basis of the acquired biometric information. Meanwhile, in an implementation example, the electronic device 100 may identify whether the user is sleeping, and when it is identified that the user is sleeping (or preparing to sleep), the processor 111 may control output of the light source on the basis of the user's biometric information.

Meanwhile, the electronic device 100 according to the various embodiments of the present disclosure may provide various smart functions.

Specifically, the electronic device 100 may be connected to a portable terminal device for controlling the electronic device 100, and a screen output from the electronic device 100 may be controlled through a user input that is input from the portable terminal device. For example, the portable terminal device may be implemented as a smartphone including a touch display, and the electronic device 100 may receive screen data provided by the portable terminal device from the portable terminal device and output the received screen data, and may control the screen output from the electronic device 100 based on the user input that is input from the portable terminal device.

The electronic device 100 may be connected to the portable terminal device through various communication methods such as Miracast, Airplay, wireless dalvik executable (DEX), and a remote personal computer (PC) method, and may share content or music provided from the portable terminal device.

In addition, the portable terminal device and the electronic device 100 may be connected to each other through various connection methods. According to the various embodiments, the portable terminal device may search for the electronic device 100 to perform a wireless connection, or the electronic device 100 may search for the portable terminal device to perform a wireless connection. In addition, the electronic device 100 may output content provided from the portable terminal device.

According to the various embodiments, when the portable terminal device is positioned near the electronic device 100 in a state in which specific content or music is being output from the portable terminal device and a predetermined gesture (e.g., motion tap view) is detected through a display of the portable terminal device, the electronic device 100 may output the content or music being output from the portable terminal device.

According to the various embodiments, when the portable terminal device approaches the electronic device 100 within a predetermined distance or less (e.g., non-contact tap view) or the portable terminal device is brought into contact with the electronic device 100 twice at a short interval (e.g., contact tap view) in a state in which specific content or music is being output from the portable terminal device, the electronic device 100 may output the content or music being output from the portable terminal device.

In the embodiments described above, it is described that the screen provided by the portable terminal device is the same as the screen provided from the electronic device 100, and the present disclosure is not limited thereto. That is, when the portable terminal device and the electronic device 100 are connected to each other, a first screen provided by the portable terminal device may be output on the portable terminal device, and a second screen different from the first screen and provided by the portable terminal device may be output on the electronic device 100. For example, the first screen may be a screen provided by a first application installed in the portable terminal device, and the second screen may be a screen provided by a second application installed in the portable terminal device. In another example, the first screen and the second screen may be different screens provided by one application installed in the portable terminal device. In addition, for example, the first screen may be a screen including a remote control-type user interface (UI) for controlling the second screen.

The electronic device 100 according to the present disclosure may output a standby screen. For example, when the electronic device 100 is not connected to the external device or when there is no input received from the external device for a predetermined time, the electronic device 100 may output the standby screen. A condition for outputting the standby screen by the electronic device 100 is not limited to the above-described example, and the standby screen may be output based on various conditions.

The electronic device 100 may output the standby screen in a blue screen form, and the present disclosure is not limited thereto. For example, the electronic device 100 may extract only a shape of a specific object from data received from the external device to acquire an irregular object, and may output a standby screen including the acquired irregular object.

Meanwhile, the electronic device 100 may further include a display (not shown).

The display (not shown) may be implemented as various types of displays such as a liquid crystal display (LCD), an organic light-emitting diode (OLED) display, and a plasma display panel (PDP). A driving circuit implemented in a form such as an amorphous silicon thin film transistor (a-si TFT), a low temperature poly silicon (LTPS) TFT, or an organic TFT (OTFT), and a backlight unit may also be included in the display (not shown). Meanwhile, the display (not shown) may be implemented as a touch screen combined with a touch sensor, a flexible display, a three-dimensional (3D) display, or the like. In addition, according to the various embodiments of the present disclosure, the display (not shown) may include not only a display panel for outputting an image, but also a bezel housing the display panel. In particular, according to the various embodiments of the present disclosure, the bezel may include a touch sensor (not shown) for sensing user interaction.

Meanwhile, the electronic device 100 may further include a shutter unit (not shown).

The shutter unit (not shown) may include at least one of a shutter, a fixing member, a rail, or a body.

Here, the shutter may block light output from the projection unit 112. Here, the fixing member may fix a position of the shutter. Here, the rail may be a route for moving the shutter and the fixing member. Here, the body may be a configuration including the shutter and the fixing member.

The processor 111 may be implemented as a digital signal processor (DSP), a microprocessor, or a time controller (TCON) for processing digital signals. However, the present disclosure is not limited thereto, and the processor 111 may include or be defined as at least one of a central processing unit (CPU), a micro controller unit (MCU), a micro processing unit (MPU), a controller, an application processor (AP), a graphics processing unit (GPU), a communication processor (CP), or an advanced reduced instruction set computer (RISC) machines (ARM) processor. In addition, the processor 111 may be implemented as a system-on-chip (SoC) or a large scale integration (LSI) in which a processing algorithm is embedded, or may be implemented as a field programmable gate array (FPGA). The processor 111 may perform various functions by executing computer executable instructions stored in the memory 113.

In particular, the processor 111 may control an operation of the electronic device 100 by executing at least one instruction stored in the memory 113. Specifically, when an event for moving the external device 200 to the first position occurs, the processor 111 may receive, from the external device 200 through the communication interface 114, the information about the second position corresponding to the current position of the external device 200. The processor 111 may acquire first route information for movement of the external device 200 to the first position on the basis of the information about first and second positions and the information about the map. The processor 111 may transmit the first route information to the external device 200 through the communication interface 114.

According to an embodiment, the processor 111 may identify whether the external device 200 is positioned within the sensing range on the basis of the information about the map and the information about the second position. When it is identified that the external device 200 is positioned within the sensing range, the processor 111 may acquire the first route information on the basis of the information about first and second positions, the information about the map, and the obstacle information sensed by the sensor 121. The processor 111 may transmit the acquired first route information to the external device 200 through the communication interface 114.

According to an embodiment, when it is identified that the external device 200 is positioned outside the sensing range, the processor 111 may acquire second route information for movement of the external device 200 to a third position within the sensing range on the basis of the information about the second position and the information about the map. The processor 111 may transmit the second route information to the external device 200 through the communication interface 114. When the external device 200 moves into the sensing range based on the second route information, the processor 111 may acquire third route information for movement of the external device 200 from the third position to the first position on the basis of the information about the first and third positions and the obstacle information. The processor 111 may transmit the third route information to the external device 200 through the communication interface 114.

According to an embodiment, when it is identified that the external device 200 is positioned outside the sensing range, the processor 111 may transmit the first route information to the external device 200 through the communication interface 114. When it is identified, by using the sensor 121, that the external device 200 is positioned within the sensing range while the external device 200 moves to the first position on the basis of the first route information, the processor 111 may acquire (or modify in real time) the first route information on the basis of the obstacle information. The processor 111 may transmit the acquired first route information to the external device 200 through the communication interface 114.

According to an embodiment, when at least one of a projector, a speaker, or a battery is included in the external device 200, the processor 111 may receive, from the external device 200 through the communication interface 141, the information about the device included in the external device 200.

According to an embodiment, the event for moving the external device 200 to the first position may be an event in which a user command is input for operating the multi-projection function by using the external device 200 including the projector and the electronic device 100. Here, when the event in which the user command is input occurs, the processor 111 may acquire the information about the first position of the external device 200 to project an image for operating a multi-projection function on the basis of the information about the map, information about a position of the electronic device 100, and information about a position of a projection surface.

According to an embodiment, the event for moving the external device 200 to the first position may be an event in which a user command is input for operating a multi-speaker function by using the external device 200 including a speaker. Here, when the event in which the user command is input occurs, the processor 111 may acquire the information about the first position for operating the multi-speaker function on the basis of the information about the map, the information about a position of the electronic device 100, and the information about a user position.

According to an embodiment, the event for moving the external device 200 to the first position may be an event in which the external device 200 includes a battery and a remaining battery level of the electronic device 100 is equal to or less than a threshold value. When the remaining battery level is detected to be equal to or less than the threshold value, the processor 111 may acquire the information about the first position corresponding to a position of the electronic device 100.

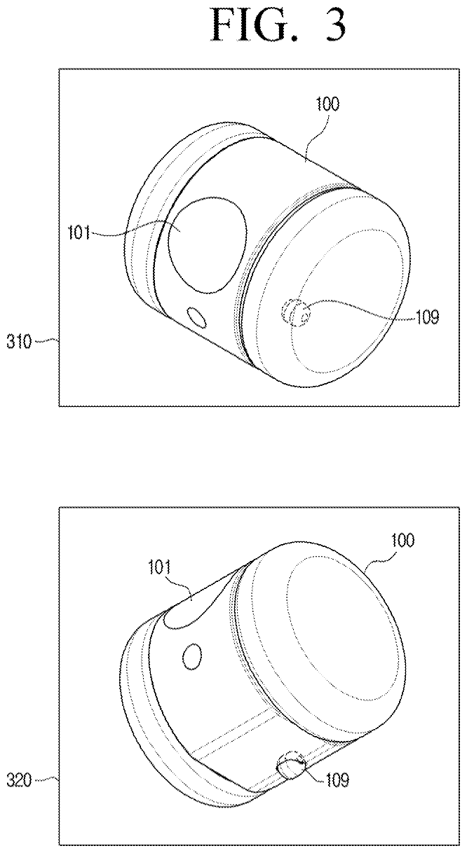

FIG. 3 is a perspective view illustrating an exterior of the electronic device 100 according to an embodiment of the present disclosure. Referring to Embodiment 310 of FIG. 3, the electronic device 100 may include the movement member 109. The movement member 109 may refer to a member for moving the electronic device 100 from the first position to the second position in a space in which the electronic device 100 is disposed. The electronic device 100 may control the movement member 109 to move the electronic device 100 by using a force generated by the driving unit 120. Here, the movement member 109 may include a motor or wheels. Embodiment 320 of FIG. 3 is a view illustrating the electronic device 100 of Embodiment 310 viewed from another direction.

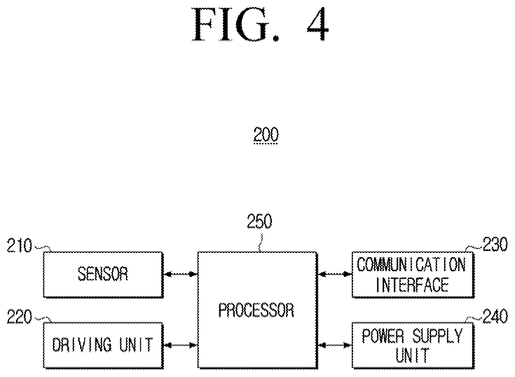

FIG. 4 is a block diagram illustrating a configuration of the external device 200 according to an embodiment of the present disclosure. As illustrated in FIG. 4, the external device 200 may include a sensor 210, a driving unit 220, a communication interface 230, a power supply unit 240, and a processor 250. Meanwhile, the components illustrated in FIG. 4 are merely various examples, and some components may be omitted, and new components may be added.

The sensor 210 is a component for preventing an obstacle or a collision with the electronic device 100 during movement of the external device 200. For example, the sensor 210 may include a position sensing device (PSD) sensor and a time of flight (ToF) sensor. In addition, the sensor 210 may include a sensor for recognizing a current position of the external device 200.

The driving unit 220 may drive at least one hardware component included in the external device 200 to move the external device 200. The driving unit 220 may generate a physical force and transmit the physical force to at least one hardware component included in the external device 200. For example, the driving unit 220 may generate driving power for movement of the hardware component included in the external device 200 (e.g., movement of the external device 200) or a rotation operation of a component (e.g., rotation of a projection lens).

The communication interface 230 may establish a communication connection with the electronic device 100 or another external device. In particular, the communication interface 230 may transmit the information about the external device 200 (e.g., the information about the current position of the external device 200 or the information about the device included in the external device 200) to the electronic device 100. The communication interface 230 may receive the route information from the electronic device 100, and may receive the information about the multi-projection system.

The power supply unit 240 may receive power from an external source and supply power to various components included in the external device 200. According to the various embodiments of the present disclosure, the power supply unit 240 may receive power through various methods. Here, the power supply unit 240 may receive power by using a battery included in the external device 200.

The processor 250 may control the external device 200 by executing at least one instruction stored in a memory (not shown). In particular, when the event for moving the external device 200 to the first position occurs, the processor 250 may acquire information about the event from the electronic device 100 through the communication interface 230. In addition, the processor 250 may acquire the information about the second position at which the external device 200 is currently positioned, and may transmit the acquired information about the second position to the electronic device 100 through the communication interface 230.

In addition, the processor 250 may acquire the information about the device provided in the external device 200, and may transmit the information about the device provided in the external device 200 to the electronic device 100 through the communication interface 230. In addition, the processor 250 may acquire function information of the external device 200 and control information of the external device 200 from the electronic device 100 through the communication interface 230. For example, when a projector is included in the external device 200, the processor 250 may acquire function information of the external device 200 and control information of the external device 200 while the multi-projection function is operated, from the electronic device 100. For example, when a speaker is included in the external device 200, the processor 250 may acquire function information of the external device 200 and control information of the external device 200 while the multi-speaker function is operated, from the electronic device 100. For example, when a battery is included in the external device 200, the processor 250 may acquire function information of the external device 200 and control information of the external device 200 for charging the battery included in the electronic device 100.

Hereinafter, the various embodiments of the present disclosure are described with reference to the drawings.

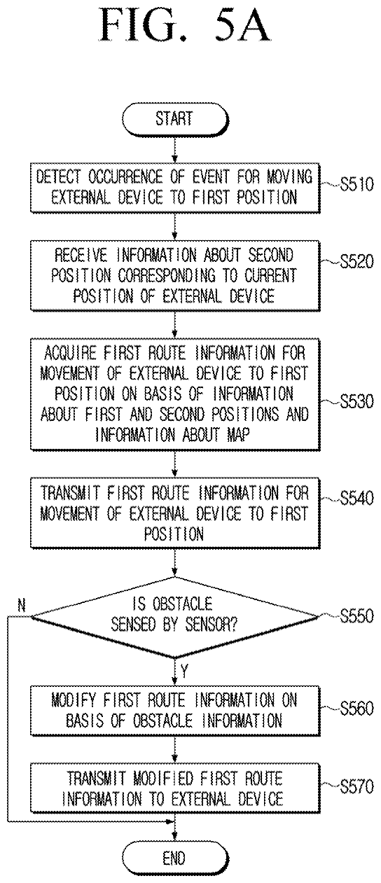

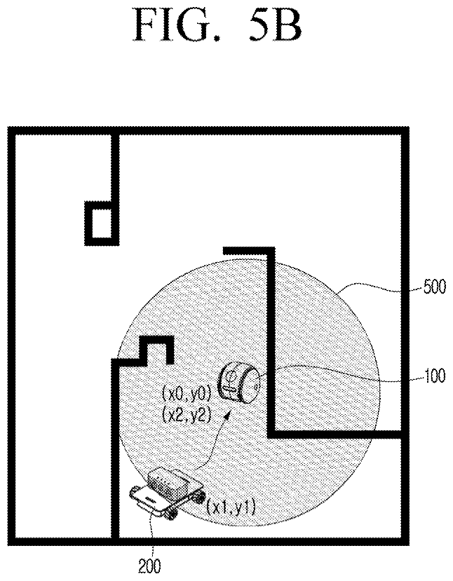

FIG. 5A is a flowchart illustrating a method of acquiring the route information when the external device 200 is positioned within the sensing range according to an embodiment of the present disclosure.

The electronic device 100 may identify that the event for moving the external device 200 to the first position occurs (S510). Here, the first position refers to a target position for performing a specific operation, and for example, as illustrated in FIG. 5B, may be a target position (x2, y2) positioned near a position (x0, y0) of the electronic device 100 to operate the multi-projection function in conjunction with the electronic device 100. However, the present disclosure is not limited thereto. The event for moving the external device 200 to the first position may be an event in which a user input for moving the external device 200 to the first position is received, or an event in which a user input for operating the multi-projection function or the multi-speaker function by using the external device 200 is received, or the like. However, the present disclosure is not limited thereto. Here, the electronic device 100 may transmit information about the event to the external device 200.

The electronic device 100 may receive, from the external device 200, the information about the second position corresponding to the current position of the external device 200 (S520). Here, the second position may be a position of the external device 200 within the sensing range of the electronic device. For example, as illustrated in FIG. 5B, the external device 200 may be positioned at a second position (x1, y1) within a sensing range 500 of the electronic device 100. The sensing range 500 may be a range in which the external device 200 or movement of the external device 200 is sensed by the sensor 121 included in the electronic device 100.

The electronic device 100 may acquire the first route information for movement of the external device 200 to the first position on the basis of information about first and second positions and the information about the map (S530). Here, the information about the map may be information about a map for representing the indoor space in which the electronic device 100 is positioned. Here, the first route information may be information about the shortest-distance route for movement of the external device 200 from the second position to the first position, which is merely an embodiment, and may be acquired on the basis of a route passing through the third position between the second position and the first position, or a route avoiding an object between the second position and the first position.

The electronic device 100 may transmit the first route information for movement of the external device 200 to the first position to the external device 200 (S540). Here, the electronic device 100 may transmit the first route information to the external device 200 through a short-range wireless communication interface (e.g., a Wi-Fi interface or a Bluetooth interface), and the present disclosure is not limited thereto. The external device 200 may move to the first position based on the first route information.

The electronic device 100 may identify whether an obstacle is sensed by the sensor (S550). Specifically, the electronic device 100 may identify whether the obstacle is sensed on a route along which the external device 200 moves to the first position, based on sensing information sensed by the sensor 121. Here, the obstacle may be a moving object (e.g., a person or a pet), and the present disclosure is not limited thereto.

When it is identified that the obstacle is sensed (S550-Y), the electronic device 100 may modify the first route information on the basis of the obstacle information (S560). Specifically, the electronic device 100 may modify the first route information to avoid the obstacle on the basis of information about the type, position, movement direction, and movement speed of the sensed obstacle.

The electronic device 100 may transmit the modified first route information to the external device 200 (S570). The external device 200 may move to the first position based on the modified first route information.

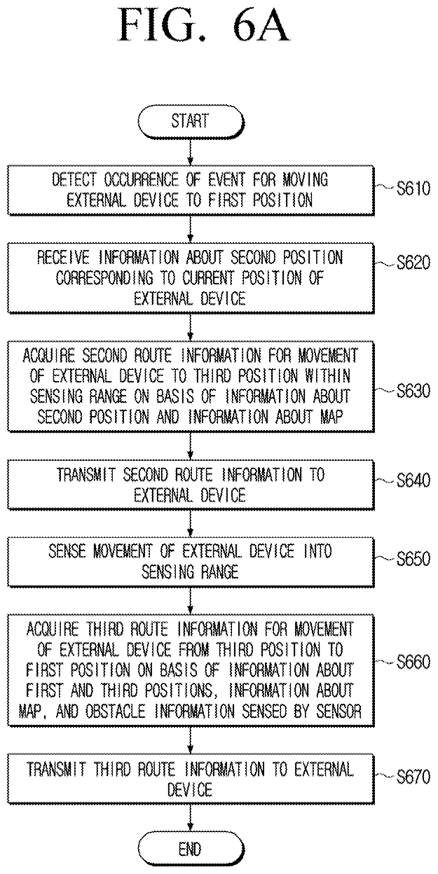

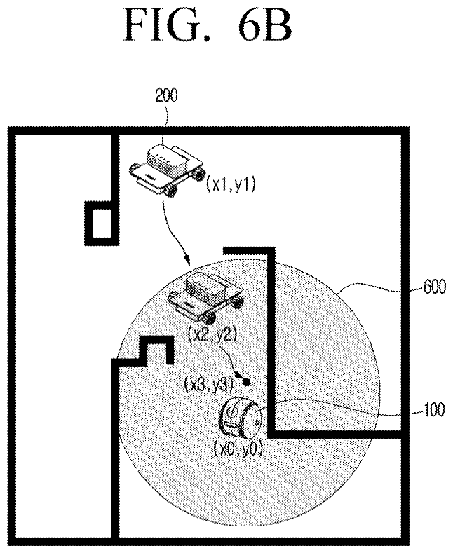

FIG. 6A is a flowchart illustrating a method of acquiring the route information when the external device 200 is positioned outside the sensing range according to an embodiment of the present disclosure. In the description provided with reference to FIG. 6A, parts identical to those provided with reference to FIG. 5A are omitted to avoid redundancy.

The electronic device 100 may identify that the event for moving the external device 200 to the first position occurs (S610). Here, the first position refers to the target position for performing a specific operation, and for example, as illustrated in FIG. 6B, may be a target position (x3, y3) positioned near the position (x0, y0) of the electronic device 100 to operate the multi-projection function in conjunction with the electronic device 100. However, the present disclosure is not limited thereto. Here, the electronic device 100 may transmit information about the event to the external device 200.

The electronic device 100 may receive, from the external device 200, the information about the second position corresponding to the current position of the external device 200 (S620). Here, the second position may be a position of the external device 200 outside the sensing range of the electronic device 100. For example, as illustrated in FIG. 6B, the external device 200 may be positioned at the second position (x1, y1) outside a sensing range 600 of the electronic device 100. The sensing range 600 may be a range in which the external device 200 or movement of the external device 200 is sensed by the sensor 121 included in the electronic device 100.

The electronic device 100 may acquire second route information for movement of the external device 200 to the third position within the sensing range on the basis of information about the second position and the information about the map (S630). For example, as illustrated in FIG. 6B, the electronic device 100 may identify an arbitrary position within the sensing range, from among positions located between a first position (x3, y3) and the second position (x1, y1), as a third position (x2, y2). Here, the third position (x2, y2) may be a position having the shortest distance to the second position (x1, y1) among points within the sensing range. However, the present disclosure is not limited thereto. In addition, the electronic device 100 may acquire the second route information on the basis of a shortest-distance route for movement of the external device 200 from the second position to the third position within the sensing range 600. However, this configuration is merely an embodiment, and the second route information may be route information acquired on the basis of a route passing through a fourth position between the second position and the third position, or a route avoiding an object between the second position and the third position.

The electronic device 100 may transmit the second route information for movement of the external device 200 to the third position to the external device 200 (S640). Here, the electronic device 100 may transmit the second route information to the external device 200 through the short-range wireless communication interface (e.g., the Wi-Fi interface or the Bluetooth interface). However, the present disclosure is not limited thereto. The external device 200 may move to the third position based on the second route information.

The electronic device 100 may sense movement of the external device 200 into the sensing range (S650). Here, the electronic device 100 may sense that the external device 200 moves to (or arrives at) the third position within the sensing range by using the sensor 121, which is merely an embodiment, and when a signal indicating that the external device 200 arrives at the third position is received from the external device 200, the electronic device 100 may sense that the external device 200 arrives at the third position within the sensing range.

The electronic device 100 may acquire the third route information for movement of the external device 200 from the third position to the first position on the basis of the information about first and third positions, the information about the map, and the obstacle information sensed by the sensor (S660). That is, when the external device 200 moves into the sensing range, the electronic device 100 may acquire (or modify) the third route information by reflecting the obstacle information in real time to move the external device 200 from the third position within the sensing range to the first position, as in the method described in S530 to S560 of FIG. 5A.

The electronic device 100 may transmit the third route information to the external device 200 (S670). Here, the external device 200 may move to the first position on the basis of the third route information.

That is, when the external device 200 is positioned outside the sensing range of the electronic device 100, the electronic device 100 may not move the external device 200 directly to the first position, and may move the external device 200 to the third position within the sensing range and then move the external device 200 from the third position to the first position.

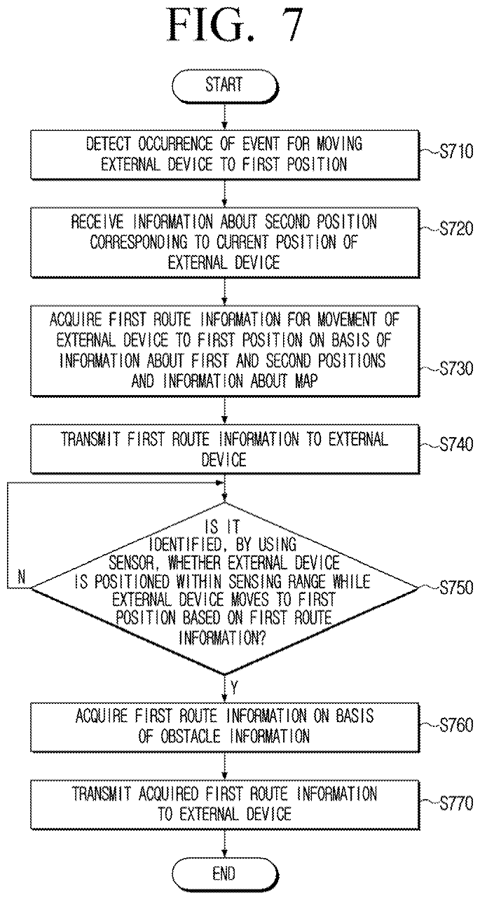

FIG. 7 is a flowchart illustrating a method of acquiring route information when the external device 200 is positioned outside the sensing range according to another embodiment of the present disclosure. In the description provided with reference to FIG. 7, parts identical to those provided with reference to FIGS. 5A and 6A are omitted to avoid redundancy.

The electronic device 100 may identify that the event for moving the external device 200 to the first position occurs (S710). Here, the first position refers to the target position for performing a specific operation, and for example, as illustrated in FIG. 6B, may be a target position (x3, y3) positioned near the position (x0, y0) of the electronic device 100 to operate the multi-projection function in conjunction with the electronic device 100. However, the present disclosure is not limited thereto. Here, the electronic device 100 may transmit information about the event to the external device 200.

The electronic device 100 may receive, from the external device 200, the information about the second position corresponding to the current position of the external device 200 (S720). Here, the second position may be a position of the external device 200 outside the sensing range of the electronic device 100. For example, as illustrated in FIG. 6B, the external device 200 may be positioned at the second position (x1, y1) outside the sensing range 600 of the electronic device 100.

The electronic device 100 may acquire the first route information for movement of the external device 200 to the first position on the basis of the information about the first and second positions and the information about the map (S730). For example, the electronic device 100 may acquire the first route information on the basis of the shortest-distance route for movement of the external device 200 from the second position (x1, y1) illustrated in FIG. 6B to the first position (x3, y3). However, this configuration is merely an embodiment, and the first route information may be route information acquired on the basis of a route passing through the third position between the second position and the first position, or a route avoiding the object between the second position and the first position.

The electronic device 100 may transmit the first route information for movement of the external device 200 to the first position to the external device 200 (S740). Here, the external device 200 may move to the first position based on the first route information.

The electronic device 100 may identify, by using the sensor 121, whether the external device 200 is positioned within the sensing range while the external device 200 moves to the first position based on the first route information (S750).

When it is identified that the external device 200 is positioned within the sensing range (S750), the electronic device 100 may acquire (or modify) the first route information on the basis of the obstacle information sensed by the sensor (S760). Specifically, the electronic device 100 may identify whether an obstacle is sensed on the route along which the external device 200 moves to the first position, based on the sensing information sensed by the sensor 121. Here, the obstacle may be a moving object (e.g., a person or a pet). However, the present disclosure is not limited thereto. The electronic device 100 may acquire (or modify) the first route information to avoid the obstacle on the basis of the information about the type, position, movement direction, and movement speed of the sensed obstacle.

The electronic device 100 may transmit the acquired first route information to the external device 200 (S770). The external device 200 may move to the first position based on the acquired first route information.

That is, when the external device 200 is positioned outside the sensing range, the electronic device 100 may move the external device 200 directly to the first position without passing through an arbitrary position within the sensing range. Here, when the external device 200 is positioned within the sensing range, the electronic device 100 may move the external device 200 to the first position after modifying the first route information by reflecting the obstacle information in real time.

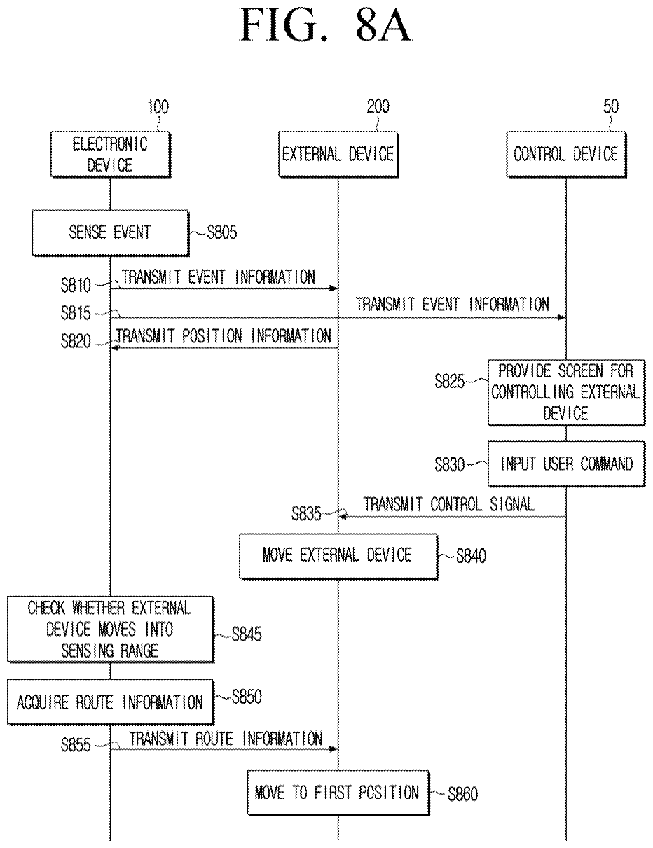

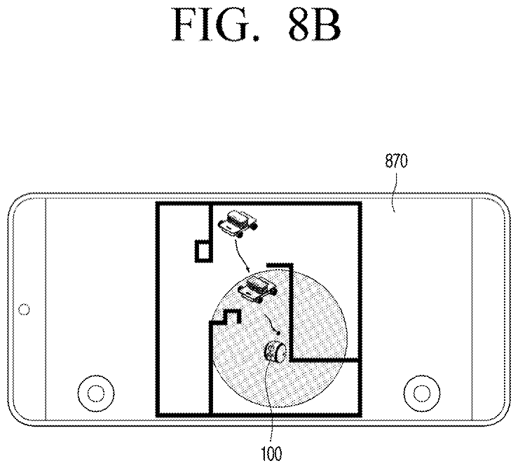

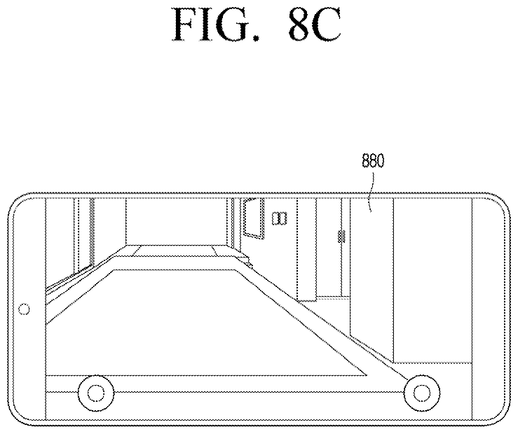

FIGS. 8A to 8C are diagrams illustrating an embodiment in which the external device 200 is controlled using a control device 50 according to an embodiment of the present disclosure.

The electronic device 100 may sense an event (S805). Here, the event refers to the event for moving the external device 200 to the first position, and may be the event in which a user input for moving the external device 200 to the first position is received, or the event in which a user input for operating the multi-projection function (or a multi-projection mode) or the multi-speaker function (or a multi-speaker mode) by using the external device 200 is received, or the like. However, the present disclosure is not limited thereto.

The electronic device 100 may transmit event information to the external device 200 (S810). In addition, the electronic device 100 may transmit the event information to the external device 200 and a control device 50 connected to the electronic device 100 (S815). Here, the event information may include information related to an event, the information about the first position, or the like, and the present disclosure is not limited thereto. In addition, the control device 50 refers to a terminal in which an application for controlling the external device 200 is installed, and may be a smartphone, which is merely an embodiment, and may be implemented as various terminals such as a tablet PC or a TV.

The external device 200 may transmit position information (S820). Here, the position information refers to the information indicating the current position of the external device 200, and may be acquired by the sensor included in the external device 200.

The control device 50 may provide a screen for controlling the external device 200 (S825). For example, the screen for controlling the external device 200 may be a screen 870 for moving the external device 200 to a position within the sensing range based on a prestored map, as illustrated in FIG. 8B, or may be a screen 880 for moving the external device 200 to a position within the sensing range by using an image captured by a camera included in the external device 200, as illustrated in FIG. 8C. However, the present disclosure is not limited thereto.

The control device 50 may receive a user command (S830). For example, when the screen 870 as illustrated in FIG. 8B is displayed, the control device 50 may receive the user command of touching a point of the map, to move the external device 200 into the sensing range, and when the screen 880 as illustrated in FIG. 8C is displayed, the control device 50 may receive the user command through a jog icon (or a UI element) included in an image, to move the external device 200 into the sensing range.

The control device 50 may transmit a control signal corresponding to the user command to the external device 200 (S835).

The external device 200 may move on the basis of the control signal (S840). Here, the external device 200 may move to a point within the sensing range of the electronic device 100.

The electronic device 100 may check (or identify) whether the external device 200 moves into the sensing range (S845). Specifically, the electronic device 100 may check whether the external device 200 moves into the sensing range by using the sensor 121, and may check whether the external device 200 moves into the sensing range on the basis of the signal received through the external device 200 or the control device 50.

The electronic device 100 may acquire the route information (S850). Specifically, the electronic device 100 may acquire (or modify) the route information for movement of the external device 200 to the first position by using the method described with reference to FIG. 5A.

The electronic device 100 may transmit the route information to the external device 200 (S855). The external device 200 may move to the first position on the basis of the route information (S860).

As described above, the external device 200 may move into the sensing range on the basis of the user command input to the control device 50. However, moving into the sensing range on the basis of the user command input to the control device 50 is merely an embodiment, and the external device 200 may move to the first position on the basis of the user command input to the control device 50.

Meanwhile, the external device 200 may include various devices (or auxiliary devices or accessory devices) performing various functions, and may configure various systems together with the electronic device 100 by using the included devices.

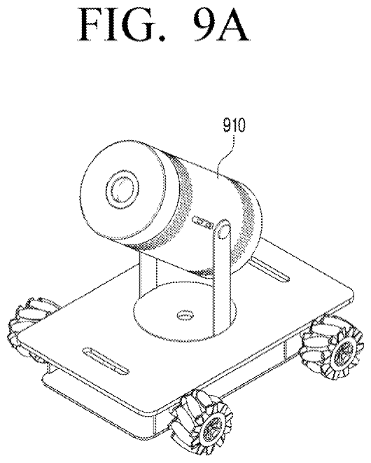

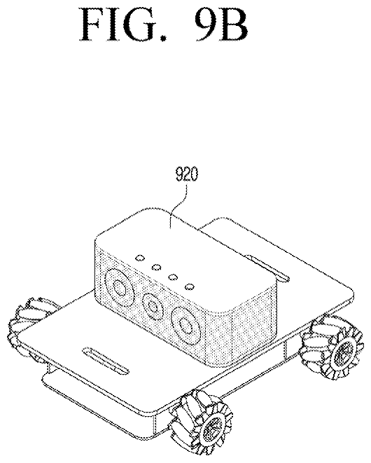

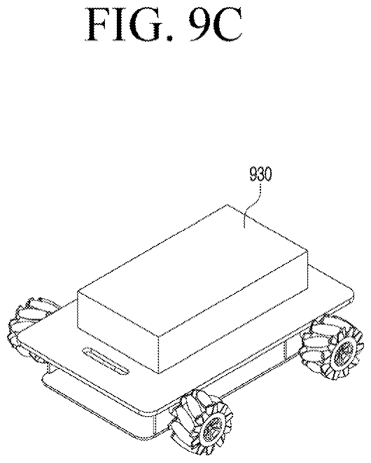

For example, as illustrated in FIG. 9A, the external device 200 may include a projector 910. Here, the projector 910 may be included in the external device 200 and may operate as a mobile projector, and may configure the multi-projection system together with the electronic device 100.

For example, as illustrated in FIG. 9B, the external device 200 may include a speaker 920. Here, the speaker 920 may include a plurality of speakers for outputting an audio signal having various frequency bands, and may configure a multi-speaker system together with the electronic device 100.

For example, as illustrated in FIG. 9C, the external device 200 may include a battery 930. Here, the battery 930 may supply power not only to the external device 200 but also to the electronic device 100. In addition, the battery 930 may supply power in a wireless charging manner, which is merely an embodiment, and may supply power in a wired charging manner.

Meanwhile, devices 910, 920, and 930 included in the external device 200 may be physically (or mechanically) mounted to the external device 200, which is merely an embodiment, and may be electrically connected thereto by using the wired or wireless communication manner. Accordingly, the external device 200 may control the devices 910, 920, and 930 disposed in the external device 200.

However, when the devices 910, 920, and 930 included in the external device 200 are physically mounted thereto and are not electrically connected thereto, the external device 200 may perform an operation of moving the provided devices 910, 920, and 930 to a specific position (e.g., the first position).

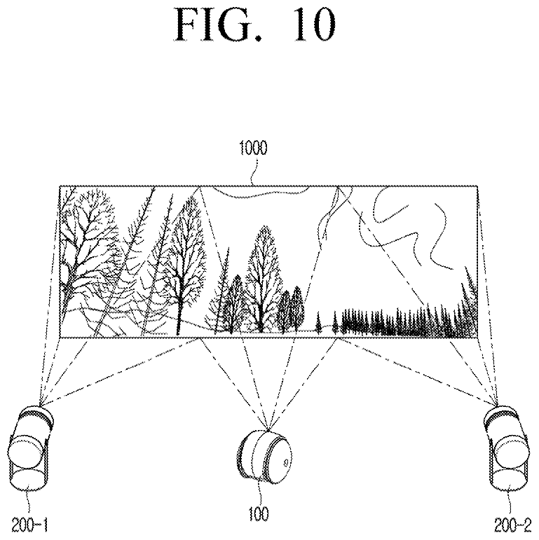

FIG. 10 is a diagram illustrating an embodiment related to a plurality of external devices 200-1 and 200-2 each including a projector according to an embodiment of the present disclosure.

After projectors are provided in a plurality of external devices 200-1 and 200-2, the electronic device 100 may receive the user command for operating the multi-projection function by using the electronic device 100 and the plurality of external devices 200-1 and 200-2. The multi-projection function may be a function for providing an image on the projection surface to the user by using a plurality of projectors.

When the user command for operating the multi-projection function is input, the electronic device 100 may receive information about a projector included in the external device and the information about the current position of the external device, from the plurality of external devices 200-1 and 200-2.

The electronic device 100 may acquire configuration information of the multi-projection function on the basis of the received information about the projector. Specifically, when the information about the projector is received from the first external device 200-1 and the second external device 200-2, the electronic device 100 may acquire configuration information for operating the multi-projection function by using the projection unit 112 of the electronic device 100 and the projectors included in the first and second external devices 200-1 and 200-2. Here, the configuration information may include information about a position of the projection surface while the multi-projection function is operated, a size of an image displayed by light projected from the plurality of devices, and a setting of the image (e.g., brightness).

The electronic device 100 may acquire information about positions to which the plurality of external devices 200-1 and 200-2 move (i.e., information about positions at which the external device 200 projects an image) on the basis of the information about the map, the position of the electronic device 100, and the position of the projection surface. For example, the electronic device 100 may acquire the information about the first position separated by a predetermined first distance from a left side of the electronic device 100, based on the projection surface, as the position to which the first external device 200-1 moves, and may acquire the information about the second position separated by a predetermined second distance from a right side of the electronic device 100, based on the projection surface, as the position to which the second external device 200-2 moves.

The electronic device 100 may acquire the first route information on the basis of a current position of the first external device 200-1, the first position, and the information about the map, and may acquire the second route information on the basis of a current position of the second external device 200-2, the second position, and the information about the map.

The electronic device 100 may transmit the first route information to the first external device 200-1, and may transmit the second route information to the second external device 200-2. The first external device 200-1 may move to the first position on the basis of the first route information, and the second external device 200-2 may move to the second position on the basis of the second route information.

The electronic device 100 may acquire function information and control information of the first external device 200-1 on the basis of the configuration information of the multi-projection function, and may transmit the acquired function information and control information to the first external device 200-1. In addition, the electronic device 100 may acquire function information and control information of the second external device 200-2 on the basis of the configuration information of the multi-projection function, and may transmit the acquired function information and control information to the second external device 200-2. Here, the function information of the external device may include information about the direction and type of an image projected by the external device 200, and the control information of the external device may include information about a projection direction of light, brightness of light, or the like.

While the electronic device 100 projects an image on the projection surface, the first external device 200-1 may project a first image on the basis of the function information and the control information, received after moving to the first position, and the second external device 200-2 may project a second image on the basis of the function information and the control information, received after moving to the second position.

Accordingly, as illustrated in FIG. 10, the electronic device 100 and the first and second external devices 200-1 and 200-2 may provide an image 1000 having an enlarged size and clear brightness to the user by operating the multi-projection function.

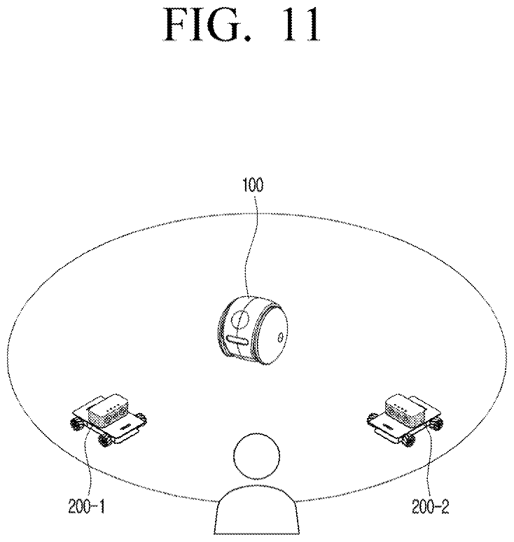

FIG. 11 is a diagram illustrating an embodiment related to the plurality of external devices 200-1 and 200-2 each including a speaker according to an embodiment of the present disclosure.

After speakers are provided in the plurality of external devices 200-1 and 200-2, the electronic device 100 may receive the user command for operating the multi-speaker function by using the electronic device 100 and the plurality of external devices 200-1 and 200-2. The multi-speaker function may be a function for providing audio to the user by using a plurality of speakers.

When the user command for operating the multi-speaker function is input, the electronic device 100 may receive information about a speaker included in the external device and the information about the current position of the external device, from the plurality of external devices 200-1 and 200-2.

The electronic device 100 may acquire configuration information of the multi-speaker function on the basis of the received information about the speaker. Specifically, when the information about the speaker is received from the first external device 200-1 and the second external device 200-2, the electronic device 100 may acquire configuration information for operating the multi-speaker function by using the speaker 117 of the electronic device 100 and the speakers included in the first and second external devices 200-1 and 200-2. Here, the configuration information may include information about an audio channel, an audio volume, or the like while the multi-projection function is operated.

The electronic device 100 may acquire information about positions to which the plurality of external devices 200-1 and 200-2 move (i.e., information about positions at which the external device 200 outputs audio) on the basis of the information about the map, the position of the electronic device 100, and the user position. For example, the electronic device 100 may acquire the information about the first position separated by the predetermined first distance from the left side of the electronic device 100, based on the user, as a position to which the first external device 200-1 moves, and may acquire the information about the second position separated by the predetermined second distance from the right side of the electronic device 100, based on the user, as a position to which the second external device 200-2 moves.

The electronic device 100 may acquire the first route information on the basis of the current position of the first external device 200-1, the first position, and the information about the map, and may acquire the second route information on the basis of the current position of the second external device 200-2, the second position, and the information about the map.

The electronic device 100 may transmit the first route information to the first external device 200-1, and may transmit the second route information to the second external device 200-2. The first external device 200-1 may move to the first position on the basis of the first route information, and the second external device 200-2 may move to the second position on the basis of the second route information.

The electronic device 100 may acquire function information and control information of the first external device 200-1 on the basis of the configuration information of the multi-speaker function, and may transmit the acquired function information and control information to the first external device 200-1. In addition, the electronic device 100 may acquire function information and control information of the second external device 200-2 on the basis of the configuration information of the multi-speaker function, and may transmit the acquired function information and control information to the second external device 200-2. Here, the function information of the external device 200 may include information about a channel of audio output by the external device 200, and the control information of the external device 200 may include information about a volume of audio, or the like.

While the electronic device 100 outputs audio, the first external device 200-1 may output first audio (e.g., audio of a left channel) on the basis of the function information and the control information, received after moving to the first position, and the second external device 200-2 may output second audio (e.g., audio of a right channel) on the basis of the function information and the control information, received after moving to the second position.

Accordingly, as illustrated in FIG. 11, the electronic device 100 and the first and second external devices 200-1 and 200-2 may provide audio having an optimal sound quality to the user by operating the multi-speaker function.

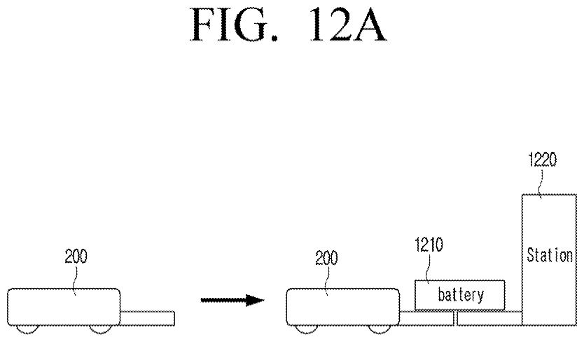

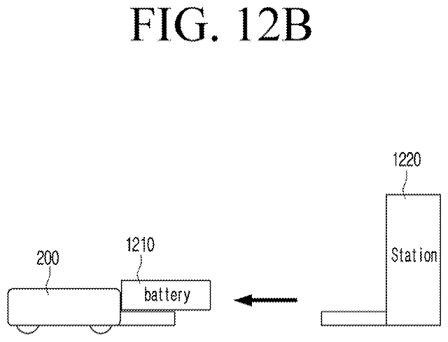

FIGS. 12A and 12B are diagrams illustrating an embodiment related to the external device 200 including a battery 1210 according to an embodiment of the present disclosure.

The electronic device 100 may monitor whether the battery level of electronic device 100 is equal to or less than the threshold value. Here, the threshold value refers to a predetermined value, and may be, for example, 15%.

When the battery level of the electronic device is equal to or less than the threshold value, the electronic device 100 may transmit, to the external device 200, information about an event in which the remaining battery level of the electronic device is detected to be equal to or less than the threshold value. The external device 200 may transmit the information about the current position of the external device 200 to the electronic device 100 on the basis of the information about the event.

The electronic device 100 may acquire the first route information for movement of the external device 200 to a station 1220 on the basis of the information about the current position of the external device 200, a position of the station 1220 at which an auxiliary battery is positioned, and the information about the map. The electronic device 100 may transmit the first route information to the external device 200.

As illustrated in FIG. 12A, the external device 200 may mount the auxiliary battery 1210 thereto after moving to the station 1220.

When the auxiliary battery 1210 is mounted thereto, the external device 200 may transmit, to the electronic device 100, information about mounting of the external battery 1210 thereto.

The electronic device 100 may acquire the second route information for movement of the external device 200 to the electronic device 100 on the basis of the position of the station, the current position of the electronic device 100, and the information about the map. The electronic device 100 may transmit the second route information to the external device 200.

The external device 200 having the auxiliary battery 1210 mounted thereto may move to the current position of the electronic device 100, as illustrated in FIG. 12B. Accordingly, the electronic device 100 may charge power of the electronic device 100 by using the auxiliary battery 1210 disposed in the external device 200. Here, the auxiliary battery 1210 may be connected to the electronic device 100 by the user to charge the power of the electronic device 100, which is merely an embodiment, and power of the electronic device 100 may be charged in various manners such as a wireless charging manner.

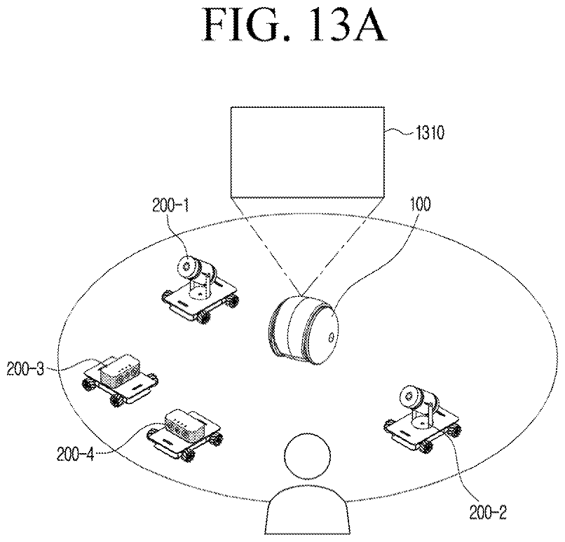

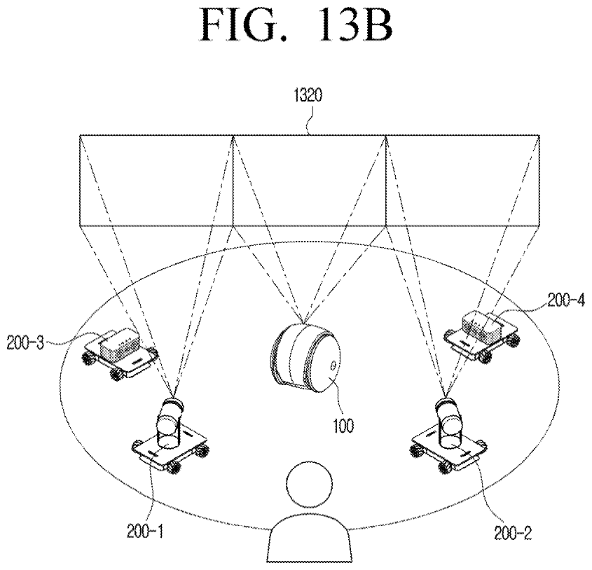

FIGS. 13A and 13B are diagrams illustrating a single projection function and the multi-projection function according to an embodiment of the present disclosure.

When a user command for operating the single projection function is input, the electronic device 100 may project an image 1310 onto the projection surface by using the projection unit 112 included in the electronic device 100, as illustrated in FIG. 13A, and may output audio corresponding to the image 1310 by using the speaker 117.

When the user command for operating the multi-projection function is input, the electronic device 100 may transmit, to a plurality of external devices 200-1 to 200-4 positioned around the electronic device 100, a signal for operating the multi-projection function. Each of the plurality of external devices 200-1 to 200-4 may transmit, to the electronic device 100, information about current positions of the plurality of external devices 200-1 to 200-4 and information about a device included in the plurality of external devices 200-1 to 200-4.

The electronic device 100 may acquire configuration information of the multi-projection function on the basis of the information about the device included in the plurality of external devices 200-1 to 200-4. For example, when information about projectors included in the external device is acquired from the first and second external devices 200-1 and 200-2, and information about speakers included in the external device is acquired from the third and fourth external devices 200-3 and 200-4, the electronic device 100 may acquire, as the configuration information of the multi-projection function, information about an image configured by three projectors and audio information of a 2.1 channel.

However, acquiring the configuration information of the multi-projection function by the electronic device 100 on the basis of the information about the device included in the plurality of external devices 200-1 to 200-4 is merely an embodiment, and the configuration information of the multi-projection function may be acquired through a user input. Here, the user input may be input through the electronic device 100, which is merely an embodiment, and may be input through the control device 50 illustrated in FIG. 8.

The electronic device 100 may acquire information about target positions for movement of the plurality of external devices 200-1 to 200-4 on the basis of positions of the plurality of external devices 200-1 to 200-4, and may acquire route information of each of the plurality of external devices 200-1 to 200-4 on the basis of the information about the target positions of the plurality of external devices 200-1 to 200-4.

The electronic device 100 may transmit route information of each of the plurality of external devices 200-1 to 200-4 to a corresponding external device. Each of the plurality of external devices 200-1 to 200-4 may move to a position for operating the multi-projection function, as illustrated in FIG. 13B, on the basis of the received route information.

The electronic device 100 may acquire function information and control information of each of the plurality of external devices 200-1 to 200-4 on the basis of the configuration information of the multi-projection function, and may transmit the acquired function information and control information to the corresponding external device.

Accordingly, as illustrated in FIG. 13B, the electronic device 100 and the plurality of external devices 200-1 to 200-4 may operate the multi-projection function to provide an enlarged image 1320 and audio having an improved sound quality.

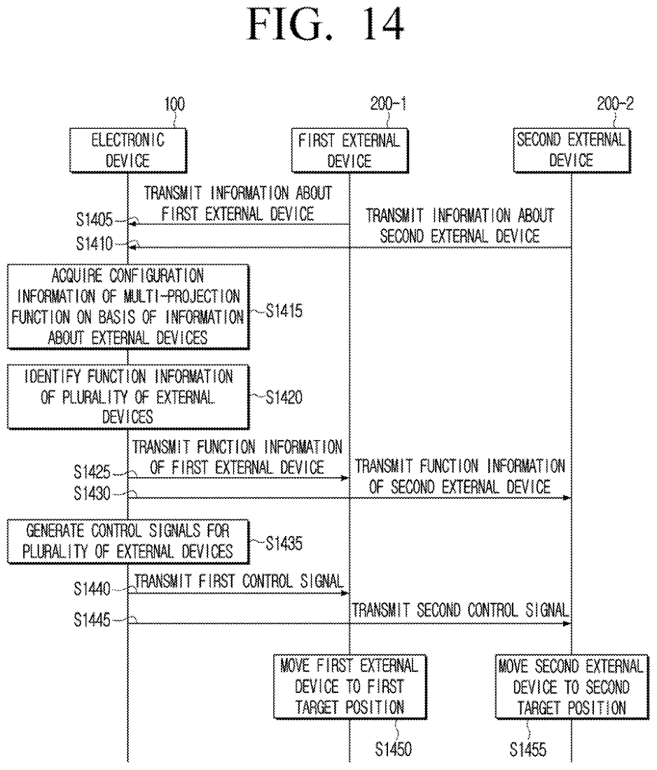

FIG. 14 is a sequence diagram illustrating a method of operating the multi-projection function in conjunction with the plurality of external devices 200-1 and 200-2 according to an embodiment of the present disclosure. Here, the electronic device 100 may be in a state in which the user input for operating the multi-projection function is received from the user, or an event for operating the multi-projection function occurs.

First, the first external device 200-1 may transmit information about the first external device 200-1 to the electronic device 100 (S1405). Here, the information about the first external device 200-1 may include information about a device included in the first external device 200-1 and the information about the current position of the first external device 200-1.

The second external device 200-2 may transmit information about the second external device 200-2 to the electronic device 100 (S1410). Here, the information about the second external device 200-2 may include information about a device included in the second external device 200-2 and information about a current position of the second external device 200-2.

The electronic device 100 may identify configuration information of the multi-projection function on the basis of information about the external devices 200-1 and 200-2 (S1415).

The electronic device 100 may identify function information of the plurality of external devices 200-1 and 200-2 (S1420). Specifically, the electronic device 100 may identify the function information of the plurality of external devices 200-1 and 200-2 on the basis of the configuration information of the multi-projection function and information about a device included in the external devices 200-1 and 200-2.

The electronic device 100 may transmit function information of the first external device 200-1 to the first external device 200-1 (S1425), and may transmit function information of the second external device 200-2 to the second external device 200-2 (S1430).

The electronic device 100 may generate control signals for the plurality of external devices 200-1 and 200-2 (S1435). Specifically, the electronic device 100 may generate the control signals for controlling the plurality of external devices 200-1 and 200-2 on the basis of the configuration information of the multi-projection function, the function information of the external devices 200-1 and 200-2, and the information about current positions of the external devices 200-1 and 200-2. Here, the control signals may include control information for controlling the devices included in the external devices 200-1 and 200-2 as well as control information for moving each of the external devices 200-1 and 200-2 to a corresponding target position.

The electronic device 100 may transmit a first control signal to the first external device 200-1 (S1440), and may transmit a second control signal to the second external device 200-2 (S1445).

The first external device 200-1 may move to a first target position on the basis of the first control signal (S1450), and the second external device 200-2 may move to a second target position on the basis of the second control signal (S1455). In addition, the first external device 200-1 may control the device included therein on the basis of the first control signal, and the second external device 200-2 may control the device included therein on the basis of the second control signal.

Meanwhile, the method of moving the external device 200 to the target position illustrated in FIGS. 10 to 14 on the basis of the current position of the external device 200, the target position, and the information about the map may use the method described with reference to FIGS. 5A to 8.

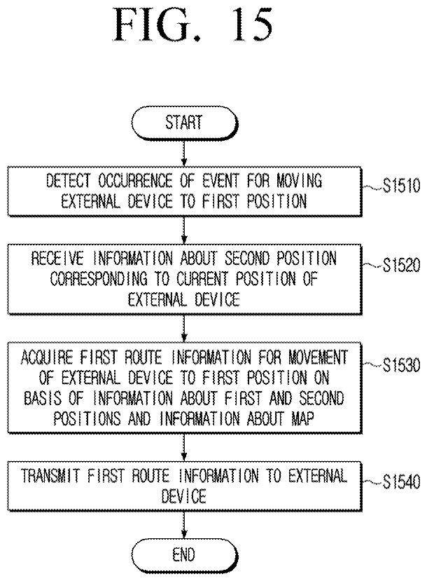

FIG. 15 is a flowchart illustrating a control method for an electronic device 100 according to an embodiment of the present disclosure.

The electronic device 100 may detect occurrence of the event for moving the external device 200 to the first position (S1510). Specifically, the event for moving the external device 200 to the first position may be the event in which the user input for moving the external device 200 to the first position is received, or the event in which the user input for operating the multi-projection function or the multi-speaker function by using the external device 200 is received. However, the present disclosure is not limited thereto. Here, the electronic device 100 may transmit the information about the event to the external device 200.

The electronic device 100 may receive, from the external device 200, the information about the second position corresponding to the current position of the external device 200 (S1520).

The electronic device 100 may acquire the first route information for movement of the external device 200 to the first position on the basis of the information about the first and second positions and the information about the map representing the indoor space in which the electronic device 100 is positioned (S1530).

Specifically, the electronic device 100 may identify whether the external device is positioned within the sensing range that may be sensed by the sensor included in the electronic device 100, on the basis of the information about the map and the information about the current position of the external device 200. When it is identified that the external device 200 is positioned within the sensing range, the electronic device 100 may acquire the first route information on the basis of the information about the first and second positions, the information about the map, and the obstacle information sensed by the sensor 121.

According to an embodiment, when it is identified that the external device 200 is positioned outside the sensing range, the electronic device 100 may acquire the second route information for movement of the external device 200 to the third position within the sensing range on the basis of the information about the second position and the information about the map. In addition, the electronic device 100 may transmit the second route information to the external device 200. When the external device moves into the sensing range based on the second route information, the electronic device 100 may acquire the third route information for movement of the external device 200 from the third position to the first position on the basis of the information about the first and third positions and the obstacle information. That is, when it is identified that the external device 200 is positioned outside the sensing range, the electronic device 100 may control the external device 200 to finally move to the first position through a second route for movement of the external device 200 to a position within the sensing range and a third route for movement of the external device 200 to the first position.

According to an embodiment, when it is identified that the external device 200 is positioned outside the sensing range, the electronic device 100 may transmit the first route information to the external device 200. The electronic device 100 may identify, by using the sensor 121, whether the external device 200 moves into the sensing range while the external device 200 moves to the first position based on the first route information. When it is identified that the external device 200 moves into the sensing range, the electronic device 100 may acquire the first route information on the basis of the obstacle information.

According to an embodiment, when the external device 200 is positioned outside the sensing range, the external device 200 may be moved into the sensing range by using the control device 50 capable of controlling movement of the external device 200. In addition, the external device 200 moved into the sensing range may be moved to the first position by the electronic device 100.

The electronic device 100 may transmit the first route information to the external device 200 (S1540). Accordingly, the external device 200 may move to the first position, which is the target position, on the basis of the first route information.

Meanwhile, the external device 200 may be a device including at least one of a projector, a speaker, or a battery. Here, when at least one of a projector, a speaker, or a battery is included in the external device 200, the electronic device 100 may receive, from the external device 200, the information about the device included in the external device 200.

According to an embodiment, the event for movement of the external device 200 to the first position may be the event in which the user command for operating the multi-projection function by using the electronic device 100 and the external device 200 including a projector is input. Here, when the event in which the user command is input occurs, the electronic device 100 may acquire the information about the first position at which the external device projects an image to operate the multi-projection function on the basis of the information about the map, the information about the position of the electronic device 100, and the information about the position of the projection surface.

According to an embodiment, when a speaker is disposed in the external device 200, the event for movement of the external device 200 to the first position may be the event in which the user command for operating the multi-speaker function by using the external device 200 including a speaker is input. Here, when the event in which the user command is input occurs, the electronic device 100 may acquire the information about the first position for operating the multi-speaker function on the basis of the information about the map, the information about the position of the electronic device 100, and the information about the user position.

According to an embodiment, the event for movement of the external device 200 to the first position may be the event in which a battery is included in the external device 200 and the remaining battery level of the electronic device 100 is equal to or less than the threshold value. Here, when the remaining battery level is detected to be equal to or less than the threshold value, the electronic device 100 may acquire the information about the first position corresponding to the position of the electronic device 100.

Meanwhile, the methods according to the various embodiments of the present disclosure may be provided as a computer program product. The computer program product may be traded as a product between a seller and a buyer. The computer program product may be distributed in a form of a machine-readable storage medium (e.g., a compact disc read only memory (CD-ROM)), or may be distributed online (e.g., by download or upload) via an application store (e.g., Play Store™) or directly between two user devices (e.g., smartphones). In the case of online distribution, at least a part of the computer program product (e.g., a downloadable application) may be at least temporarily stored or temporarily generated in a machine-readable storage medium such as a memory of a manufacturer server, an application store server, or a relay server.

The methods according to the various embodiments of the present disclosure may be implemented by software including instructions stored in a machine-readable storage medium, the instructions being readable by a machine (e.g., a computer). The machine may be a device that invokes the stored instruction from a storage medium, may be operated based on the invoked instruction, and may include the electronic device (e.g., a TV) according to the disclosed embodiments.

Meanwhile, the machine-readable storage medium may be provided in the form of a non-transitory storage medium. Here, the term “non-transitory storage medium” means a tangible device and does not include a signal (e.g., an electromagnetic wave), and this term does not distinguish a case in which data is stored semi-permanently in the storage medium and a case in which data is temporarily stored. For example, the “non-transitory storage medium” may include a buffer in which data is temporarily stored.

When the instructions are executed by the processor, the processor may perform functions corresponding to the instructions directly or by using other components under control of the processor. The instructions may include code generated or executed by a compiler or an interpreter.

Although the preferred embodiments of the present disclosure have been illustrated and described above, the present disclosure is not limited to the above-described specific embodiments, and various modifications may be made by those skilled in the art to which the present disclosure pertains without departing from the gist of the present disclosure as claimed in the claims, and such modifications should also be understood to fall within the spirit or scope of the present disclosure.

What is claimed is:

1. An electronic device comprising:
a communication interface;
memory including at least one instruction; and
at least one processor connected to the communication interface and the memory and configured to control the electronic device,
wherein the at least one processor is configured to:
when an event for moving an external device to a first position occurs,
receive, from the external device through the communication interface, information about a second position corresponding to a current position of the external device,
acquire first route information for a movement of the external device to the first position, the acquiring the first route information being based on information about the first and the second positions and information about a map, and
transmit the first route information to the external device through the communication interface.

2. The apparatus as claimed in claim 1, further comprising:
a sensor,
wherein the at least one processor is further configured to:
when the external device is identified as being positioned within a sensing range of the sensor based on the information about the map and the information about the second position,
acquire the first route information based on the information about the first and the second positions, the information about the map, and obstacle information sensed by the sensor, and
transmit the acquired first route information to the external device through the communication interface.

3. The apparatus as claimed in claim 2, wherein the at least one processor is further configured to:
when the external device is identified as being positioned outside the sensing range,
acquire second route information for a movement of the external device to a third position within the sensing range, the acquiring the second route information being based on the information about the second position and the information about the map, and
transmit the second route information to the external device through the communication interface; and
when the external device moves into the sensing range based on the second route information,
acquire third route information for a movement of the external device from the third position to the first position, the acquiring the third route information being based on the information about the first and the third positions and the obstacle information, and
transmit the third route information to the external device through the communication interface.

4. The apparatus as claimed in claim 2, wherein the at least one processor is further configured to:
when the external device is identified as being positioned outside the sensing range,
transmit the first route information to the external device through the communication interface; and
by using the sensor, when the external device is identified as being positioned within the sensing range while the external device moves to the first position based on the first route information,
acquire the first route information based on the obstacle information, and
transmit the acquired first route information to the external device through the communication interface.

5. The apparatus as claimed in claim 2, wherein when the external device is identified as being positioned outside the sensing range, the external device is moved into the sensing range by using a control device capable of controlling movement of the external device.

6. The apparatus as claimed in claim 1, wherein the external device is a device including at least one of a projector, a speaker, or a battery.

7. The apparatus as claimed in claim 6, wherein the at least one processor is further configured to:
when at least one of the projector, the speaker, or the battery is included in the external device,
receive information about the device included in the external device from the external device through the communication interface.

8. The apparatus as claimed in claim 6, wherein the event for moving the external device to the first position is an event in which a user command is input for operating a multi-projection function by using the external device including the projector and the electronic device, and
the at least one processor is further configured to:
when the event in which the user command is input occurs,
acquire information about the first position of the external device to project an image for operating the multi-projection function, the acquiring the information about the first position being based on the information about the map, information about a position of the electronic device, and information about a position of a projection surface.

9. The apparatus as claimed in claim 6, wherein the event for moving the external device to the first position is an event in which a user command is input for operating a multi-speaker function by using the external device including the speaker, and
the at least one processor is further configured to:
when the event in which the user command is input occurs,
acquire information about the first position for operating the multi-speaker function, the acquiring the information about the first position being based on the information about the map, information about a position of the electronic device, and information about a user position.

10. The apparatus as claimed in claim 6, wherein the event for moving the external device to the first position is an event in which the external device includes a battery, and a remaining battery level of the electronic device is equal to or less than a threshold value, and
the at least one processor is further configured to:
when the remaining battery level is detected to be equal to or less than the threshold value,
acquire information about the first position corresponding to a position of the electronic device.

11. A control method performed by an electronic device, the method comprising:
when an event for moving an external device to a first position occurs,
receiving, from the external device, information about a second position corresponding to a current position of the external device;
acquiring first route information for a movement of the external device to the first position, the acquiring the first route information being based on the information about the first and the second positions and information about a map; and
transmitting the first route information to the external device.

12. The control method as claimed in claim 11, wherein the acquiring of the first route information comprises:
when the external device is identified as being positioned within a sensing range of a sensor included in the electronic device based on the information about the map and the information about the second position,
acquiring the first route information based on the information about the first and the second positions, the information about the map, and obstacle information sensed by the sensor.

13. The control method as claimed in claim 12, wherein the acquiring of the first route information further comprises:
when the external device is identified as being positioned outside the sensing range,
acquiring second route information for a movement of the external device to a third position within the sensing range, the acquiring the second route information being based on the information about the second position and the information about the map, and
transmitting the second route information to the external device; and
when the external device moves into the sensing range based on the second route information,
acquiring third route information for a movement of the external device from the third position to the first position, the acquiring the third route information being based on the information about the first and the third positions and the obstacle information.

14. The control method as claimed in claim 12, wherein the acquiring of the first route information further comprises:
when the external device is identified as being positioned outside the sensing range,
transmitting the first route information to the external device; and
by using the sensor, when the external device is identified as being positioned within the sensing range while the external device moves to the first position based on the first route information,
acquiring the first route information based on the obstacle information.

15. The control method as claimed in claim 12, wherein, when the external device is identified as being positioned outside the sensing range, the external device is moved into the sensing range by using a control device capable of controlling movement of the external device.
